(19) United States
(12) Patent Application Publication
(10) Pub. No.: US 2026/0213442 A1
(43) Pub. Date: Jul. 23, 2026

(54) COMPACT HIGH-DENSITY ELECTRICAL CONNECTOR

(71) Applicant: Amphenol Commercial Products (Chengdu) Co., Ltd., Chengdu (CN)

(72) Inventors: Xiaodong Hu, Chengdu (CN); Teng Cao, Chengdu (CN); Lei Liao, Shenzhen (CN); Hongyan Guo, Chengdu (CN); Genggeng Chen, Chengdu (CN)

(73) Assignee: Amphenol Commercial Products (Chengdu) Co., Ltd., Chengdu (CN)

(21) Appl. No.: 19/455,975

(22) Filed: Jan. 22, 2026

(30) Foreign Application Priority Data
Jan. 23, 2025 (CN) 202520159147.9

(51) Int. Cl. H01R 12/73; H01R 13/6471

(52) U.S. Cl. CPC H01R 12/737; H01R 13/6471

(57) ABSTRACT

Compact high-density electrical connectors configured to provide high-speed, high-performance transmission. An electrical connector includes a row of terminals configured for signal or ground, and a conductive member spanning the row and coupled (e.g., welded) to the terminals configured for ground. The conductive member has a row of beams configured for contacting ground pads of a card. The connector has a second row of terminals configured for signal and ground. The conductive member has another row of beams configured for contacting ground terminals in the second row. Such a configuration can direct the return of energy onto the conductive member and thus provide an improved shielding effect.

### CROSS-REFERENCE TO RELATED APPLICATIONS

This application claims priority to and the benefit of Chinese Patent Application No. 202520159147.9, filed on Jan. 23, 2025. The contents of this application are incorporated herein by reference in their entirety.

### TECHNICAL FIELD

The present application relates to interconnection systems, such as those including electrical connectors, configured to interconnect electronic assemblies.

### BACKGROUND

Electrical connectors are used in many electronic systems. It is generally easier and more cost-effective to manufacture a system as separate electronic subassemblies, such as printed circuit boards (PCBs), which may be joined together by electrical connectors. Having separable electrical connectors enables components of the electronic system manufactured by different manufacturers to be readily assembled. Separable electrical connectors also enable components to be readily replaced after the system is assembled, either to replace defective components or to upgrade the system with higher-performance components.

A card edge connector is a commonly used electrical connector, which may include an insulative housing having a slot and conductive terminals disposed in the insulative housing. Mating contact portions of the conductive terminals extend into the slot. Tail ends of the conductive terminals may establish direct electrical connections with conductive portions of a first circuit board, such as a motherboard, or may be attached with cables that are connected to conductive portions of a first circuit board, such as a motherboard. An edge portion of a second circuit board, such as a daughter card (which may also be referred to as “a card” or “add-in card”), may be inserted into the slot, so that contact pads on the edge portion may be in contact with the mating contact portions of the conductive terminals. In this way, an electrical connection may be established between the first circuit board and the second circuit board via the card edge connector. The card edge connector and the daughter card are typically designed and manufactured according to specific specifications to mate with each other and to meet signal and power transmission requirements. Examples of such specifications include DDR standards such as DDR4, DDR5, or DDR6, Serial ATA (SATA), Serial Attached SCSI (SAS), or Peripheral Component Interconnect Channel (PCIe). Over time, these standards have undergone many modifications to accommodate higher performance requirements for computer devices.

### SUMMARY

Aspects of the present application relates to compact high-density electrical connectors.

Some embodiments relate to a terminal group for an electrical connector comprising a housing having a slot elongated in a longitudinal direction, the terminal group configured to be disposed on one side of the slot, the terminal group comprising a plurality of first conductive terminals disposed in a first row extending in the longitudinal direction, the plurality of first conductive terminals comprising first signal terminals and first ground terminals; a plurality of second conductive terminals disposed in a second row extending in the longitudinal direction and spaced from the first row in a lateral direction perpendicular to the longitudinal direction, the plurality of second conductive terminals comprising second signal terminals and second ground terminals; and a conductive member disposed between the first row and the second row and electrically connecting the first ground terminals of the plurality of first conductive terminals in the first row and the second ground terminals of the plurality of second conductive terminals in the second row.

Optionally, each first conductive terminal comprises a first mating end having a first mating contact portion curving into the slot from said side of the slot; and each second conductive terminal comprises a second mating end having a second mating contact portion curving into the slot from said side of the slot.

Optionally, the conductive member comprises a plurality of first resilient beams disposed in a third row extending in the longitudinal direction; and each first resilient beam comprises a third mating contact portion curving into the slot from said side of the slot.

Optionally, the first mating contact portions of the plurality of first conductive terminals are aligned in a first line; the second mating contact portions of the plurality of second conductive terminals are aligned in a second line parallel to the first line and spaced from the first line in a vertical direction perpendicular to both the longitudinal direction and the lateral direction; and the third mating contact portions of the plurality of first resilient beams are aligned in a third line, the third line parallel to the first line and between the first line and the second line in the vertical direction.

Optionally, the first line, the second line, and the third line are coplanar in a plane perpendicular to the lateral direction.

Optionally, the conductive member comprises a plate-shaped body.

Optionally, each first conductive terminal comprises a first tail end and a first intermediate portion between the first mating end and the first tail end, both the first intermediate portion and the first mating end disposed on a first side of the body of the conductive member; and each second conductive terminal further comprises a second tail end and a second intermediate portion between the second mating end and the second tail end, the second intermediate portion disposed on a second side of the body of the conductive member opposite to the first side in the lateral direction, and the second mating end disposed on the first side of the conductive member.

Optionally, the conductive member comprises a plurality of second resilient beams extending from the body and toward the first intermediate portions of respective first ground terminals of the plurality of first conductive terminals.

Optionally, the conductive member comprises a plurality of extensions extending from the body and toward the second intermediate portions of respective second ground terminals.

Some embodiments relate to an electrical connector comprising a housing comprising a slot elongated in a longitudinal direction; and a terminal group disposed on one side of the slot, the terminal group comprising a plurality of first conductive terminals held by the housing in a first row extending in the longitudinal direction, a subassembly housing disposed in the housing and comprising a plurality of openings, a plurality of second conductive terminals held by the subassembly housing in a second row extending in the longitudinal direction, intermediate portions of second ground conductive terminals at least partially exposed by respective openings of the plurality of openings of the subassembly housing, and a conductive member disposed on the subassembly housing and comprising a plurality of extensions extending into respective openings of the plurality of openings of the subassembly housing so as to electrically connect the second ground conductive terminals with first ground conductive terminals.

Optionally, the plurality of extensions of the conductive member are welded to the intermediate portions of the second ground conductive terminals.

Optionally, the first ground conductive terminals and first signal conductive terminals are disposed in alternative in the first row; the second ground conductive terminals and second signal conductive terminals are disposed in alternative in the second row; the first ground conductive terminals are aligned with respective second signal conductive terminals in a lateral direction perpendicular to the longitudinal direction; and the second ground conductive terminals are aligned with respective first signal conductive terminals in the lateral direction.

Optionally, the conductive member comprises a plurality of first resilient beams aligned with respective second ground conductive terminals in the lateral direction.

Optionally, each first conductive terminal comprises a first mating end having a first mating contact portion curving into the slot; each second conductive terminal comprises a second mating end having a second mating contact portion curving into the slot; and each first resilient beam comprises a third mating contact portion curving into the slot.

Optionally, the first mating contact portions are aligned in a first line; the second mating contact portions are aligned in a second line parallel to the first line and spaced from the first line in a vertical direction perpendicular to both the longitudinal direction and the lateral direction; and the third mating contact portions are aligned in a third line, the third line parallel to the first line and between the first line and the second line in the vertical direction.

Optionally, the conductive member comprises a plurality of second resilient beams aligned with respective first ground conductive terminals in the lateral direction.

Some embodiments relate to a card, comprising an edge portion configured to be inserted into a slot of an electrical connector in a vertical direction and comprising a first surface and a second surface opposite to each other in a lateral direction perpendicular to the vertical direction; a plurality of first signal contact pads disposed on the first surface, the plurality of first signal contact pads disposed in a first row in a longitudinal direction perpendicular to the vertical direction and the lateral direction and comprising a plurality of subsets, a plurality of second signal contact pads disposed on the first surface, the plurality of second signal contact pads disposed in a second row in the longitudinal direction and comprising a plurality of subsets; and a ground contact pad disposed on the first surface and comprising a body disposed between the first row and the second row in the vertical direction and extending in the longitudinal direction, a plurality of first extensions each extending from the body in the vertical direction to a position between corresponding two adjacent subsets of first signal contact pads of the first row, and a plurality of second extensions each extending from the body in the vertical direction to a position between corresponding two adjacent subsets of second signal contact pads of the second row.

Optionally, each subset of first signal contact pad of the first row is aligned with a corresponding one of the plurality of second extensions in the vertical direction; and each subset of second signal contact pad of the second row is aligned with a corresponding one of the plurality of first extensions in the vertical direction.

Optionally, each subset of first signal contact pad of the first row is disposed in a U-shaped region bounded by two adjacent first extensions and the body of the ground contact pad; and each subset of second signal contact pad of the second row is disposed in a U-shaped region bounded by two adjacent second extensions and the body of the ground contact pad.

Optionally, each subset of first signal contact pad of the first row comprises a single first signal contact pad, and the plurality of first signal contact pads and the plurality of first extensions are alternately disposed in the longitudinal direction; and each subset of second signal contact pad of the second row comprises a single second signal contact pad, and the plurality of second signal contact pads and the plurality of second extensions are alternately disposed in the longitudinal direction.

Some embodiments relate to a terminal group for an electrical connector comprising an insulative housing having a slot elongated in a longitudinal direction. The terminal group is configured to be disposed on one side of the slot in a lateral direction perpendicular to the longitudinal direction, and comprises: a plurality of first conductive terminals disposed in a first row in the longitudinal direction and comprising first signal terminals and first ground terminals; a plurality of second conductive terminals disposed in a second row in the longitudinal direction and comprising second signal terminals and second ground terminals, the first row and the second row mutually opposed to and spaced apart from each other in the lateral direction; and a conductive member disposed between the first row and the second row and electrically coupled to the first ground terminals and the second ground terminals.

Optionally, each first conductive terminal comprises a first mating end having a first mating contact portion configured to curve into the slot; and each second conductive terminal comprises a second mating end having a second mating contact portion configured to curve into the slot.

Optionally, the conductive member comprises a plurality of first resilient beams disposed in a third row in the longitudinal direction, and each first resilient beam has a third mating contact portion configured to curve into the slot.

Optionally, the first mating contact portions of the plurality of first conductive terminals are aligned in a first line; the second mating contact portions of the plurality of second conductive terminals are aligned in a second line, which is parallel to the first line and spaced apart from the first line in a vertical direction perpendicular to the longitudinal direction and the lateral direction; and the third mating contact portions of the first plurality of resilient beams are aligned in a third line, which is parallel to the first line and between the first line and the second line in the vertical direction.

Optionally, the first line is parallel to the longitudinal direction.

Optionally, the first line, the second line, and the third line are coplanar in a plane perpendicular to the lateral direction.

Optionally, the insulative housing comprises a mating face, the slot is recessed into the insulative housing from the mating face in the vertical direction, and the second line is closer to the mating face than the first line in the vertical direction.

Optionally, the slot is configured to receive a card, and the first mating contact portions of the plurality of first conductive terminals, the second mating contact portions of the plurality of second conductive terminals, and the third mating contact portions of the plurality of first resilient beams are for contacting corresponding conductive pads on one and the same side of the card when the card is received in the slot.

Optionally, the conductive member further comprises a plate-shaped body extending in a first main plane perpendicular to the lateral direction and located between the first row and the second row.

Optionally, each first conductive terminal further comprises a first tail end opposite to the first mating end and a first intermediate portion extending between the first mating end and the first tail end, the first intermediate portions of the plurality of first conductive terminals are aligned in the longitudinal direction; each second conductive terminal further comprises a second tail end opposite to the second mating end and a second intermediate portion extending between the second mating end and the second tail end, the second intermediate portions of the plurality of second conductive terminals are aligned in the longitudinal direction; for each first conductive terminal, the first intermediate portion and the first mating end are located on a first side of the body adjacent to the slot in the lateral direction; and for each second conductive terminal, the second intermediate portion is located on a second side of the body opposite to the first side in the lateral direction, and the second mating end extends from the second intermediate portion on the second side and over an edge of the body to the first side so that the second mating contact portion is located on the first side.

Optionally, for each second conductive terminal, the second mating end is in an inverted U-shape and comprises a first segment extending from the second intermediate portion, a second segment forming the second mating contact portion, and a third segment joining the first segment and the second segment, the third segment forms a top of the inverted U-shape.

Optionally, the second mating end of each second conductive terminal bounds an inverted U-shaped space, and the edge of the body extends, in a vertical direction perpendicular to the longitudinal direction and the lateral direction, into the inverted U-shaped space bounded by the second mating end of the second signal terminal.

Optionally, for each second conductive terminal, the first segment is closer to the edge of the body in the lateral direction than the second segment.

Optionally, the insulative housing comprises a mating face, the slot is recessed into the insulative housing from the mating face in a vertical direction perpendicular to the longitudinal direction and the lateral direction, for each second conductive terminal, the first segment extends from the second intermediate portion toward the mating face, and the second segment extends from the third segment away from the mating face and is convexly curved toward the slot.

Optionally, each of the plurality of first resilient beams extends from the body toward the first side so that the third mating contact portion is located on the first side.

Optionally, each first resilient beam is in an inverted U-shape and comprises a first segment extending from the body, a second segment forming the third mating contact portion, and a third segment joining the first segment and the second segment, the third segment forms a top of the inverted U-shape.

Optionally, the insulative housing comprises a mating face, the slot is recessed into the insulative housing from the mating face in a vertical direction perpendicular to the longitudinal direction and the lateral direction, for each first resilient beam, the first segment extends from the body toward the mating face, and the second segment extends from the third segment away from the mating face and is convexly curved toward the slot.

Optionally, each first resilient beam is a portion integrally stamped from the body and connected to the body at a first fixed end, the first fixed end is indented into the body relative to the edge of the body in a vertical direction perpendicular to the longitudinal direction and the lateral direction.

Optionally, a second mating end of each second ground terminal of the plurality of second conductive terminals is aligned with a corresponding one of the plurality of first resilient beams in a vertical direction perpendicular to the longitudinal direction and the lateral direction.

Optionally, in the first row, the first signal terminals and the first ground terminals are alternately disposed in the longitudinal direction; in the second row, the second signal terminals and the second ground terminals are alternately disposed in the longitudinal direction; and each first signal terminal of the first row is aligned with a corresponding second ground terminal of the second row in the lateral direction, and each second signal terminal of the second row is aligned with a corresponding first ground terminal of the first row in the lateral direction.

Optionally, the first mating contact portion of each first signal terminal is aligned with the second mating contact portion of the corresponding second ground terminal and the third mating contact portion of a corresponding one of the plurality of first resilient beams in a vertical direction perpendicular to the longitudinal direction and the lateral direction, and the third mating contact portion is located between the first mating contact portion and the second mating contact portion; and the second mating contact portion of each second signal terminal is aligned with the first mating contact portion of the corresponding first ground terminal in the vertical direction.

Optionally, the conductive member further comprises a plurality of first extensions each aligned with a corresponding first ground terminal of the first row in the lateral direction and extending from the body toward the corresponding first ground terminal so as to be in direct contact or capacitive coupling with the first intermediate portion of the corresponding first ground terminal.

Optionally, each first extension is in the form of a second resilient beam extending from the body toward the first intermediate portion of the corresponding first ground terminal and resiliently abutting against the first intermediate portion.

Optionally, for each first conductive terminal, the first intermediate portion comprises a first segment extending in a vertical direction perpendicular to the longitudinal direction and the lateral direction, and a second segment extending obliquely from the first segment and away from the body of the conductive member to the first mating end; the first segments of the first intermediate portions of the plurality of first conductive terminals are coplanar in a plane parallel to the first main plane; and each second resilient beam resiliently abuts against the first segment of the first intermediate portion of the corresponding first ground terminal.

Optionally, the insulative housing comprises a mating face, the slot is recessed into the insulative housing from the mating face in a vertical direction perpendicular to the longitudinal direction and the lateral direction; and each second resilient beam comprises a first segment extending obliquely from the body away from the mating face and toward the first intermediate portion of the corresponding first ground terminal to the second segment, and a second segment convexly curved toward the first intermediate portion of the corresponding first ground terminal to abut against the first intermediate portion.

Optionally, the edge of the body is a first edge, the body further comprises a second edge, the first edge and the second edge are opposite to each other in the vertical direction, and the first edge is closer to the mating face than the second edge; and each of the plurality of second resilient beams is a portion integrally stamped from the body of the conductive member and is connected with the body at a second fixed end, the second fixed end is indented into the body relative to the second edge in the vertical direction.

Optionally, the conductive member further comprises a plurality of second extensions each aligned with a corresponding second ground terminal of the second row in the lateral direction and extending from the body toward the second intermediate portion of the corresponding second ground terminal so as to be in direct contact or capacitive coupling with the second intermediate portion.

Optionally, the terminal group further comprises an insulative subassembly housing disposed around the second intermediate portions of the plurality of second conductive terminals to hold the plurality of second conductive terminals, the subassembly housing comprises a plurality of openings each aligned, in the lateral direction, with the second intermediate portion of a corresponding second ground terminal of the second row and exposing the portion of the second intermediate portion; and the body of the conductive member is disposed on the subassembly housing, and each second extension is aligned with and received in a corresponding one of the plurality of openings in the lateral direction so as to be in direct contact or capacitive coupling with the portion of the second intermediate portion of the corresponding second ground terminal.

Optionally, each second extension is in the form of a rib comprising: a bottom segment in direct contact or capacitive coupling with the portion of the second intermediate portion of the corresponding second ground terminal; and a first side segment and a second side segment opposing to each other in the longitudinal direction and connecting the bottom segment to the body, respectively.

Optionally, for each second conductive terminal, the second intermediate portion extends in a vertical direction perpendicular to the longitudinal direction and the lateral direction; the second intermediate portions of the plurality of second conductive terminals are coplanar in a plane parallel to the first main plane; and for each rib, the bottom segment is in direct contact with the portion of the second intermediate portion of the corresponding second ground terminal, and the direct contact is a face contact.

Optionally, each rib has a U-shaped cross section perpendicular to the vertical direction.

Optionally, each rib is a portion that is integrally stamping from the body.

Optionally, for each rib, the bottom segment is welded on the portion of the second intermediate portion of the corresponding second ground terminal.

Optionally, each first resilient beam is a portion integrally stamped from the body of the conductive member, and is connected with the body at a first fixed end, and the position of the first fixed end of each first resilient beam is aligned, in the vertical direction, with the position where a corresponding rib is formed on the body.

Optionally, a length of the portion of the second intermediate portion of the corresponding second ground terminal in the vertical direction occupies more than 50% of a total length of the second intermediate portion in the vertical direction.

Optionally, the subassembly housing comprises a first planar face extending parallel to the first main plane, the plurality of openings are recessed into the subassembly housing from the first face in the lateral direction, the body of the conductive member comprises a second planar face, the rib is disposed to protrude from the second face, the body is disposed on the subassembly housing so that the second face is placed on the first face and each rib is received in the corresponding opening.

Optionally, the subassembly housing is a member overmolded on the second intermediate portions of the plurality of second conductive terminals.

Optionally, the subassembly housing is configured to be disposed in the insulative housing of the electrical connector.

Optionally, in the second row, the second signal terminals and the second ground terminals are alternately disposed in the longitudinal direction; and for each second signal terminal, a center of the second intermediate portion is spaced apart from the body of the conductive member by a first distance in the lateral direction and spaced apart from an edge of an adjacent second ground terminal by a second distance in the longitudinal direction, the first distance is less than or equal to the second distance.

Optionally, for each second signal terminal, the second intermediate portion is separated from the body of the conductive member by the subassembly housing in the lateral direction.

Optionally, in the first row, the first signal terminals and the first ground terminals are alternately disposed in the longitudinal direction; and each first signal terminal of the first row is aligned with a corresponding second ground terminal of the second row in the lateral direction, and each second signal terminal of the second row is aligned with a corresponding first ground terminal of the first row in the lateral direction.

Optionally, the body of the conductive member has a first edge and a second edge opposite to each other in a vertical direction perpendicular to the longitudinal direction and the lateral direction, a dimension of the body between the first edge and the second edge in the vertical direction is greater than or equal to a length of the second intermediate portion of each second signal terminal in the vertical direction.

Optionally, the body of the conductive member has a third edge and a fourth edge opposite to each other in the longitudinal direction, a dimension of the body between the third edge and the fourth edge in the longitudinal direction is greater than or equal to a length of each of the first row and the second row in the longitudinal direction.

Optionally, the electrical connector is configured to be mounted to a circuit board, for each first conductive terminal, the first tail end is located on the first side of the body in the lateral direction and configured to be soldered to a corresponding conductive pad on the circuit board, for each second conductive terminal, the second tail end is located on the second side of the body in the lateral direction and configured to be soldered to a corresponding conductive pad on the circuit board.

Optionally, for each first conductive terminal, the first tail end is located on the first side of the body in the lateral direction, and for each second conductive terminal, the second tail end is located on the second side of the body in the lateral direction, and the body does not extend to a position between the first tail ends of the plurality of first conductive terminals and the second tail ends of the plurality of second conductive terminals in a vertical direction perpendicular to the longitudinal direction and the lateral direction.

Optionally, the conductive member is formed from a metallic material or a lossy material.

Optionally, the terminal group is configured to be disposed in the insulative housing.

Optionally, the terminal group has no portion disposed on the other side of the slot opposite to the one side in the lateral direction.

Optionally, each of the plurality of first conductive terminals is configured to be held in position directly by the insulative housing.

Some embodiments relate to an electrical connector. The electrical connector comprises: an insulative housing having a slot elongated in a longitudinal direction; and the aforementioned terminal group, wherein the terminal group is disposed on one side of the slot in a lateral direction perpendicular to the longitudinal direction.

Optionally, the terminal group is a first terminal group, and the electrical connector further comprises a second terminal group disposed on the other side of the slot opposite to the one side in the lateral direction, and opposing to the first terminal group across the slot, the second terminal group comprises: a plurality of third conductive terminals disposed in a third row in the longitudinal direction and comprising third signal terminals and third ground terminals; a plurality of fourth conductive terminals disposed in a fourth row in the longitudinal direction and comprising fourth signal terminals and fourth ground terminals, the third row and the fourth row are opposing and spaced apart from each other in the lateral direction; and a second conductive member disposed between the third row and the fourth row and electrically coupled to the third ground terminals and the fourth ground terminals.

Optionally, in the first row, the first signal terminals and the first ground terminals are alternately disposed in the longitudinal direction; in the second row, the second signal terminals and the second ground terminals are alternately disposed in the longitudinal direction; in the third row, the third signal terminals and the third ground terminals are alternately disposed in the longitudinal direction; in the fourth row, the fourth signal terminals and the fourth ground terminals are alternately disposed in the longitudinal direction; the first row is closer to the slot than the second row in the lateral direction, and the third row is closer to the slot than the fourth row in the lateral direction; and each first signal terminal of the first row is aligned, in the lateral direction, with a corresponding second ground terminal of the second row, a corresponding third ground terminal of the third row, and a corresponding fourth signal terminal of the fourth row, and each second signal terminal of the second row is aligned, in the lateral direction, with a corresponding first ground terminal of the first row, a corresponding third signal terminal of the third row, and a corresponding fourth ground terminal of the fourth row.

Some embodiments relate to a card. The card comprises: an edge portion configured to be inserted into a slot of an electrical connector in a vertical direction and comprising a first surface and a second surface opposite to each other in a lateral direction perpendicular to the vertical direction; a plurality of first signal contact pads disposed on the first surface, the plurality of first signal contact pads disposed in a first row in a longitudinal direction perpendicular to the vertical direction and the lateral direction and comprising a plurality of subsets; a plurality of second signal contact pads disposed on the first surface, the plurality of second signal contact pads disposed in a second row in the longitudinal direction and comprising a plurality of subsets; and a ground contact pad disposed on the first surface and comprising: a body disposed between the first row and the second row in the vertical direction and extending continuously in the longitudinal direction; a plurality of first extensions each extending from the body in the vertical direction to a position between corresponding two adjacent subsets of first signal contact pads of the first row; and a plurality of second extensions each extending from the body in the vertical direction to a position between corresponding two adjacent subsets of second signal contact pads of the second row.

Optionally, each subset of first signal contact pad of the first row is aligned with a corresponding one of the plurality of second extensions in the vertical direction.

Optionally, each subset of second signal contact pad of the second row is aligned with a corresponding one of the plurality of first extensions in the vertical direction.

Optionally, each subset of first signal contact pad of the first row is disposed in a U-shaped region bounded by two adjacent first extensions and the body of the ground contact pad.

Optionally, each subset of second signal contact pad of the second row is disposed in a U-shaped region bounded by two adjacent second extensions and the body of the ground contact pad.

Optionally, each subset of first signal contact pad of the first row comprises a single first signal contact pad, and the plurality of first signal contact pads and the plurality of first extensions are alternately disposed in the longitudinal direction.

Optionally, each subset of second signal contact pad of the second row comprises a single second signal contact pad, and the plurality of second signal contact pads and the plurality of second extensions are alternately disposed in the longitudinal direction.

Optionally, each subset of first signal contact pad of the first row comprises a pair of first signal contact pads configured as a differential signal pair.

Optionally, each subset of second signal contact pad of the second row comprises a pair of second signal contact pads configured as a differential signal pair.

Optionally, the body extends straightly in the longitudinal direction.

Optionally, the body is in a strip shape.

Optionally, each first signal contact pad is in a finger shape.

Optionally, each second signal contact pad is in a finger shape.

Optionally, each first extension is in a finger shape.

Optionally, each second extension is in a finger shape.

Optionally, the plurality of first signal contact pads, the plurality of second signal contact pads, and the ground contact pad are disposed in a two-dimensional array on the first surface.

Optionally, the ground contact pad is a first ground contact pad, and the card further comprises: a plurality of third signal contact pads disposed on the second surface, the plurality of third signal contact pads are disposed in a third row in the longitudinal direction and comprising a plurality of subsets; a plurality of fourth signal contact pads disposed on the second surface, the plurality of fourth signal contact pads are disposed in a fourth row in the longitudinal direction and comprising a plurality of subsets; and a second ground contact pad disposed on the second surface and comprising: a second body disposed between the third row and the fourth row in the vertical direction and extending continuously in the longitudinal direction; a plurality of third extensions each extending from the second body in the vertical direction to a position between corresponding two adjacent subsets of third signal contact pads of the third row; and a plurality of fourth extensions each extending from the second body in the vertical direction to a position between corresponding two adjacent subsets of fourth signal contact pads of the fourth row.

Optionally, each subset of third signal contact pads of the third row is aligned with a corresponding one of the plurality of fourth extensions in the vertical direction, and each subset of fourth signal contact pads of the fourth row is aligned with a corresponding one of the plurality of third extensions in the vertical direction; the body of the first ground contact pad is aligned with the second body of the second ground contact pad in the lateral direction; each subset of first signal contact pad of the first row is aligned with a corresponding one of the plurality of third extensions in the lateral direction, and each subset of second signal contact pad of the second row is aligned with a corresponding one of the plurality of fourth extensions in the lateral direction; and each subset of third signal contact pads of the third row is aligned with a corresponding one of the plurality of first extensions in the lateral direction, and each subset of fourth signal contact pads of the fourth row is aligned with a corresponding one of the plurality of second extensions in the lateral direction.

Some embodiments relate to an electronic system. The electronic system comprises: an electrical connector comprising: an insulative housing having a slot elongated in a longitudinal direction; a plurality of first conductive terminals disposed in a first row in the longitudinal direction and comprising first ground terminals; a plurality of second conductive terminals disposed in a second row in the longitudinal direction and comprising second ground terminals, the first row and the second row disposed on one side of the slot in a lateral direction perpendicular to the longitudinal direction and opposed to and spaced apart from each other in the lateral direction; and a conductive member disposed between the first row and the second row; and a card comprising: an edge portion inserted into the slot in a vertical direction perpendicular to the longitudinal direction and the lateral direction and comprising a first surface and a second surface opposite to each other in the lateral direction; and a ground contact pad disposed on the first surface, the ground contact pad in contact with the first ground terminals of the first row and the second ground terminals of the second row; wherein the conductive member is electrically coupled to the first ground terminals of the first row, the second ground terminals of the second row, and the ground contact pad.

Optionally, the conductive member comprises a plurality of first resilient beams disposed in a row in the longitudinal direction, and each first resilient beam has a third mating contact portion curved into the slot; and the ground contact pad comprises a first body extending continuously in the longitudinal direction and in contact with the third mating contact portions of the plurality of first resilient beams.

Optionally, each first conductive terminal comprises a first mating end having a first mating contact portion curved into the slot; each second conductive terminal comprises a second mating end having a second mating contact portion curved into the slot; and the first body of the ground contact pad comprises a first side edge and a second side edge opposite to each other in the vertical direction, and the ground contact pad further comprises: a plurality of first extensions each extending from the first side edge in the vertical direction and aligned and in contact with a first mating contact portion of a corresponding first ground terminal of the first row in the lateral direction; and a plurality of second extensions each extending from the second side edge in the vertical direction and aligned and in contact with a second mating contact portion of a corresponding second ground terminal of the second row in the lateral direction.

Optionally, the plurality of first conductive terminals further comprises first signal terminals, and the plurality of second conductive terminals further comprises second signal terminals, the first ground terminals separate the first signal terminals into a plurality of first subsets, and the second ground terminals separate the second signal terminals into a plurality of second subsets; the card further comprises a plurality of first signal contact pads and a plurality of second signal contact pads disposed on the first surface, the plurality of first signal contact pads are disposed in a third row in the longitudinal direction, and the plurality of second signal contact pads are disposed in a fourth row in the longitudinal direction; the first body of the ground contact pad is positioned between the third row and the fourth row in the vertical direction; each first extension extends to a position between the plurality of first signal contact pads in the vertical direction and separates the plurality of first signal contact pads into a plurality of third subsets, and each second extension extends to a position between the plurality of second signal contact pads and separates the plurality of second signal contact pads into a plurality of fourth subsets in the vertical direction; and each first signal contact pad of the third row is aligned and in contact with a corresponding first signal terminal of the first row in the lateral direction, and each second signal contact pad of the fourth row is aligned and in contact with a corresponding second signal terminal of the second row in the lateral direction.

Optionally, the first mating contact portions of the plurality of first conductive terminals are aligned in a first line; the second mating contact portions of the plurality of second conductive terminals are aligned in a second line, which is parallel to the first line and spaced apart from the first line in the vertical direction; and the third mating contact portions of the plurality of first resilient beams are aligned in a third line, which is parallel to the first line and between the first line and the second line in the vertical direction.

Optionally, the first line is parallel to the longitudinal direction.

Optionally, the first line, the second line, and the third line are coplanar in a plane perpendicular to the lateral direction.

Optionally, the insulative housing comprises a mating face, the slot is recessed into the insulative housing from the mating face in the vertical direction, and the second line is closer to the mating face in the vertical direction than the first line.

Optionally, the conductive member further comprises a plate-shaped second body extending in a first main plane perpendicular to the lateral direction and located between the first row and the second row.

Optionally, each first conductive terminal further comprises a first tail end opposite to the first mating end and a first intermediate portion extending between the first mating end and the first tail end, the first intermediate portions of the plurality of first conductive terminals are aligned in the longitudinal direction; each second conductive terminal further comprises a second tail end opposite to the second mating end and a second intermediate portion extending between the second mating end and the second tail end, the second intermediate portions of the plurality of second conductive terminals are aligned in the longitudinal direction; for each first conductive terminal, the first intermediate portion and the first mating end are located on a first side of the second body adjacent to the slot in the lateral direction; and for each second conductive terminal, the second intermediate portion is on a second side of the second body opposite to the first side in the lateral direction, and the second mating end extends from the second intermediate portion on the second side and over an edge of the second body to the first side so that the second mating contact portion is located on the first side.

Optionally, for each second conductive terminal, the second mating end is in an inverted U-shape and comprises a first segment extending from the second intermediate portion, a second segment forming the second mating contact portion, and a third segment joining the first segment and the second segment, the third segment forms a top of the inverted U-shape.

Optionally, each first resilient beam extends from the second body toward the first side so that the third mating contact portion is located on the first side; and each first resilient beam is in an inverted U-shape and comprises a first segment extending from the second body, a second segment forming the third mating contact portion, and a third segment joining the first segment and the second segment, the third segment forms a top of the inverted U-shape.

Optionally, each subset of first signal terminal of the first row comprises a single first signal terminal, and in the first row, the first signal terminals and the first ground terminals are alternately disposed in the longitudinal direction; each subset of second signal terminal of the second row comprises a single second signal terminal, and in the second row, the second signal terminals and the second ground terminals are alternately disposed in the longitudinal direction; and each first signal terminal of the first row is aligned with a corresponding second ground terminal of the second row in the lateral direction, and each second signal terminal of the second row is aligned with a corresponding first ground terminal of the first row in the lateral direction.

Optionally, a first mating contact portion of each first signal terminal is aligned with the second mating contact portion of the corresponding second ground terminal and the third mating contact portion of a corresponding one of the plurality of first resilient beams in the vertical direction, and the third mating contact portion is located between the first mating contact portion and the second mating contact portion; and the second mating contact portion of each second signal terminal is aligned with the first mating contact portion of the corresponding first ground terminal in the vertical direction.

Optionally, the conductive member further comprises a plurality of second resilient beams extending from the second body, each second resilient beam is aligned with a corresponding first ground terminal of the first row in the lateral direction and extends from the second body toward the first intermediate portion of the corresponding first ground terminal to resiliently abut against the first intermediate portion.

Optionally, for each first conductive terminal, the first intermediate portion comprises a first segment extending in the vertical direction, and a second segment extending obliquely from the first segment away from the second body of the conductive member to the first mating end; the first segments of the first intermediate portions of the plurality of first conductive terminals are coplanar with a plane parallel to the first main plane; and each second resilient beam resiliently abuts against the first segment of the first intermediate portion of the corresponding first ground terminal.

Optionally, the insulative housing comprises a mating face, the slot is recessed into the insulative housing from the mating face in the vertical direction; and each second resilient beam comprises a first segment extending obliquely from the second body away from the mating face and toward the first intermediate portion of the corresponding first ground terminal to the second segment, and a second segment convexly curved toward the first intermediate portion of the corresponding first ground terminal to abut against the first segment of the first intermediate portion.

Optionally, the conductive member further comprises a plurality of ribs extending from the second body, each rib is aligned, in the lateral direction, with a corresponding second ground terminal of the second row and extends from the second body toward the second intermediate portion of the corresponding second ground terminal so as to be in direct contact or capacitive coupling with a portion of the second intermediate portion.

Optionally, a cross section of each rib perpendicular to the vertical direction has a U-shaped profile, and each rib comprises: a bottom segment welded to the portion of the second intermediate portion of the corresponding second ground terminal; and a first side segment and a second side segment opposing to each other in the longitudinal direction and connecting the bottom segment to the second body, respectively.

Optionally, the electrical connector further comprises an insulative subassembly housing disposed around the second intermediate portions of the plurality of second conductive terminals to hold the plurality of second conductive terminals, the subassembly housing comprises a plurality of openings each aligned with the second intermediate portion of a corresponding second ground terminal of the second row in the lateral direction and exposing the portion of the second intermediate portion; and the second body of the conductive member is disposed on the subassembly housing, and each rib is aligned with and received in a corresponding one of the plurality of openings in the lateral direction.

Optionally, for each second conductive terminal, the second intermediate portion extends in the vertical direction; the second intermediate portions of the plurality of second conductive terminals are coplanar in a plane parallel to the first main plane; and for each rib, the bottom segment is in direct contact with the portion of the second intermediate portion of the corresponding second ground terminal, and the direct contact is a face contact.

Optionally, the electrical connector further comprises: a plurality of third conductive terminals disposed in a fifth row in the longitudinal direction and comprising third ground terminals; a plurality of fourth conductive terminals disposed in a sixth row in the longitudinal direction and comprising fourth ground terminals, the fifth tow and the sixth row are disposed on the other side of the slot opposite to the one side in the lateral direction and are mutually opposed to and spaced apart from each other in the lateral direction; and a second conductive member disposed between the fifth row and the sixth row; the card further comprises a second ground contact pad disposed on the second surface, the second ground contact pad is in contact with the third ground terminals of the fifth row and the fourth ground terminals of the sixth row; and wherein the second conductive member is electrically coupled to the third ground terminals of the fifth row, the fourth ground terminals of the sixth row, and the second ground contact pad.

These techniques can be used individually or in any suitable combination. The preceding summary is provided by way of illustration and is not meant to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a perspective view of an electronic system including a first circuit board, a second circuit board, and an electrical connector, according to some embodiments of the present application;

FIG. 1B is a partially exploded view of the electronic system of FIG. 1A;

FIG. 2A is a perspective view illustrating a first side of the second circuit board of FIG. 1A;

FIG. 2B is a perspective view illustrating a second side of the second circuit board of FIG. 2A opposite to the first side;

FIG. 2C is an enlarged view of the area 2C circled by the dashed box in FIG. 2A;

FIG. 3A is a top perspective view of the electrical connector of FIG. 1A;

FIG. 3B is a bottom perspective view of the electrical connector of FIG. 1A;

FIG. 3C is an enlarged view of the area 3C circled by the dashed box in FIG. 3A;

FIG. 3D is an enlarged view of the area 3D circled by the dashed box in FIG. 3B;

FIG. 3E is an enlarged view of the area 3D, with a cover member and solder balls of the electrical connector removed to show terminal groups disposed in an insulative housing;

FIG. 3F is an enlarged view of the area 3D, with the terminal groups of the electrical connector further removed to show channels of the insulative housing for disposing the terminal groups;

FIG. 4A is a cross-sectional view taken along a line marked “4A-4A” in FIG. 3A;

FIG. 4B is an enlarged view of the area 4B circled by the dashed box in FIG. 4A;

FIG. 4C is a cross-sectional view taken along a line marked “4C-4C” in FIG. 3A;

FIG. 4D is an enlarged view of the area 4D circled by the dashed box in FIG. 4C;

FIG. 5 is a partially exploded view of the electrical connector of FIG. 1A;

FIG. 6A is a perspective view of a set of first and second terminal groups of the electrical connector of FIG. 5, with the insulative housing of the electrical connector removed to show the relative positional relationship of the set of first and second terminal groups when assembled in the insulative housing;

FIG. 6B is a top view of the set of first and second terminal groups of FIG. 6A;

FIG. 6C is a bottom view of the set of first and second terminal groups of FIG. 6A;

FIG. 7A schematically illustrates a relative positional relationship of the set of first and second terminal groups of FIG. 6A relative to a second circuit board when the second circuit board is inserted in the electrical connector, wherein the insulative housing of the electrical connector is removed;

FIG. 7B is an enlarged view of the area 7B circled by the dashed box of FIG. 7A;

FIG. 8A is a perspective view of the first terminal group of the set of FIG. 6A;

FIG. 8B is an exploded view of the first terminal group of FIG. 8A including a plurality of first conductive terminals, a plurality of second conductive terminals, a conductive member, and a first subassembly housing;

FIG. 8C is another exploded view of the first terminal group of FIG. 8A;

FIG. 8D is a front view of the first terminal group of FIG. 8A;

FIG. 8E is a cross-sectional view taken along line 8E-8E in FIG. 8D;

FIG. 8F is a cross-sectional view taken along line 8F-8F in FIG. 8D;

FIG. 8G is another perspective view of the first terminal group of FIG. 8A, with the plurality of first conductive terminals of the first terminal group removed;

FIG. 8H is a cross-sectional view taken along line 8H-8H in FIG. 8G;

FIG. 9A is an enlarged view of the area 9A circled by the dashed box in FIG. 8B;

FIG. 9B is an enlarged view of the area 9B circled by the dashed box of FIG. 8C;

FIG. 9C is an enlarged view of the area 9C circled by the dashed box in FIG. 8B;

FIG. 9D is an enlarged view of the area 9D circled by the dashed box in FIG. 8C;

FIG. 9E is an enlarged view of the area 9E circled by the dashed box in FIG. 8B;

FIG. 9F is an enlarged view of the area 9F circled by the dashed box in FIG. 8C;

FIG. 10A is a top perspective view of the cover member of the electrical connector;

FIG. 10B is a bottom perspective view of the cover member of the electrical connector;

FIG. 11A is a perspective view illustrating another version of the first terminal group;

FIG. 11B is another perspective view of the first terminal group of FIG. 11A;

FIG. 11C is an enlarged view of the area 11C circled by the dashed box in FIG. 11A;

FIG. 11D is an enlarged view of the area 11D circled by the dashed box in FIG. 11B; and

FIG. 12 is an enlarged view similar to FIG. 3D, illustrating an embodiment in which the first terminal group of FIG. 11A is installed into the insulative housing.

### DETAILED DESCRIPTION

The inventors have recognized and appreciated techniques for making compact high-density electrical connector that can provide high-speed, high-performance transmission. These techniques may be applied to card edge connectors, such as memory card connectors, to meet performance requirements specified by standards, such as DDR4, DDR5, DDR6, or higher DDR standards and/or DIMM standards while providing higher terminal densities. Further, it should be appreciated that these techniques may be applied to other types of electrical connectors, such as receptacle connectors for mating with plug connectors.

According to aspects of the present disclosure, an electrical connector may include a row of terminals configured for signal or ground, and a conductive member spanning the row and coupled (e.g., welded) to the terminals configured for ground. The conductive member may have a row of beams configured for contacting ground pads of a card. The connector may have a second row of terminals configured for signal and ground. The conductive member may have another row of beams configured for contacting ground terminals in the second row. Such a configuration may direct the return of energy onto the conductive member and thus provide an improved shielding effect.

In some embodiments, an electrical connector includes an insulative housing having a slot elongated in a longitudinal direction. The terminal group is configured to be disposed on one side of the slot in a lateral direction perpendicular to the longitudinal direction. The terminal group according to the present application can provide conductive terminals with double density on the same side of the slot as compared to a conventional card edge connector having only a single row of terminals on one and the same side of the slot. For example, the terminal group may include a plurality of first conductive terminals and a plurality of second conductive terminals. The plurality of first conductive terminals are disposed in a first row in the longitudinal direction and include first signal terminals and first ground terminals. The plurality of second conductive terminals are disposed in a second row in the longitudinal direction and include second signal terminals and second ground terminals. The first row and the second row are opposed to and spaced apart from each other in the lateral direction. The terminal group may further include a conductive member disposed between the first row and the second row and electrically coupled to the first ground terminals and the second ground terminals. Such a configuration of the terminal group can maintain or improve signal integrity when providing a higher terminal density, thereby enabling the electrical connector to operate at higher speeds and having a greater number of terminals to provide more independent signal paths.

In some embodiments, a first mating contact portion of each first conductive terminal of the terminal group curves into the slot, and a second mating contact portion of each second conductive terminal of the terminal group curves into the slot. The conductive member of the terminal group may include a plurality of first resilient beams disposed in a third row in the longitudinal direction. Each first resilient beam has a third mating contact portion curved into the slot. With such a configuration, the first mating contact portions of the plurality of first conductive terminals, the second mating contact portions of the plurality of second conductive terminals, and the third mating contact portions of the plurality of first resilient beams curve into the slot on the same side of the slot for contacting with corresponding conductive pads on one and the same side of the edge portion when the edge portion of the circuit board is received in the slot, thereby establishing electrical connections therebetween.

In some embodiments, the circuit board may be referred to as a card. The card may include an edge portion, a ground contact pad, a plurality of first signal contact pads, and a plurality of second signal contact pads. The edge portion is configured to be inserted into the slot of the electrical connector in a vertical direction perpendicular to the longitudinal direction and the lateral direction, and includes a first surface and a second surface opposite to each other in the lateral direction. A ground contact pad, a plurality of first signal contact pads, and a plurality of second signal contact pads are disposed on a first surface of the edge portion. The plurality of first signal contact pads are disposed in a first row in the longitudinal direction and comprise a plurality of subsets. Each subset may include a single first signal contact pad or a pair of first signal contact pads. The plurality of second signal contact pads are disposed in a second row in the longitudinal direction and comprise a plurality of subsets. Each subset may include a single second signal contact pad or a pair of second signal contact pads. The ground contact pad includes a body, a plurality of first extensions, and a plurality of second extensions. The body is disposed between the first row and the second row in the vertical direction and extends continuously in the longitudinal direction. Each first extension extends from the body in the vertical direction to a position between corresponding two adjacent subsets of first signal contact pads of the first row. Each second extension extends from the body in the vertical direction to a position between corresponding two adjacent subsets of second signal contact pads of the second row. Such a configuration of the card can maintain or improve signal integrity while providing a higher signal contact pad density, enabling the card to operate at higher speeds and having a greater number of signal contact pads to provide more independent signal paths.

In some embodiments, the edge portion of the card may be inserted into the slot of the electrical connector so that the card establishes electrical connections with the electrical connector to form an electronic system. Each first signal contact pad is in contact with the first mating contact portion of a corresponding first signal terminal of the first row of the terminal group, each second signal contact pad is in contact with the second mating contact portion of a corresponding second signal terminal of the second row of the terminal group, each first extension of the ground contact pad is in contact with the first mating contact portion of a corresponding first ground terminal of the first row of the terminal group, each second extension of the ground contact pad is in contact with the second mating contact portion of a corresponding second ground terminal of the second row of the terminal group, and the body of the ground contact pad is in contact with the third mating contact portions of the plurality of first resilient beams. In this way, ground and signal connections can be established between the card and the electrical connector.

In some embodiments, another terminal group, which is similar to the terminal group, may be provided on the other side of the slot of the electrical connector. A similar contact pad pattern may be provided on the second surface of the edge portion of the card for mating with the other terminal group. Such a configuration enables the electronic system to operate at higher speeds and to have a greater number of independent signal paths.

Some embodiments of the present application are described in detail below in connection with the appended drawings.

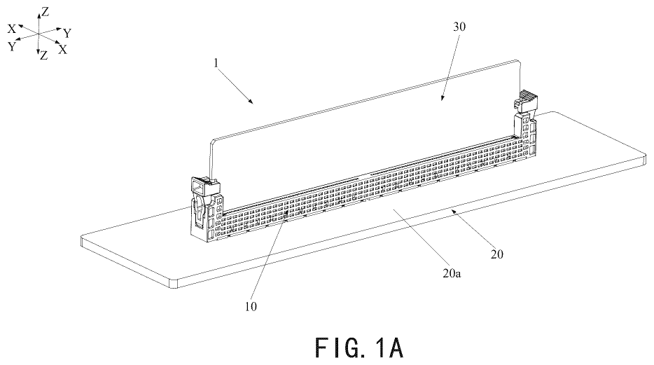

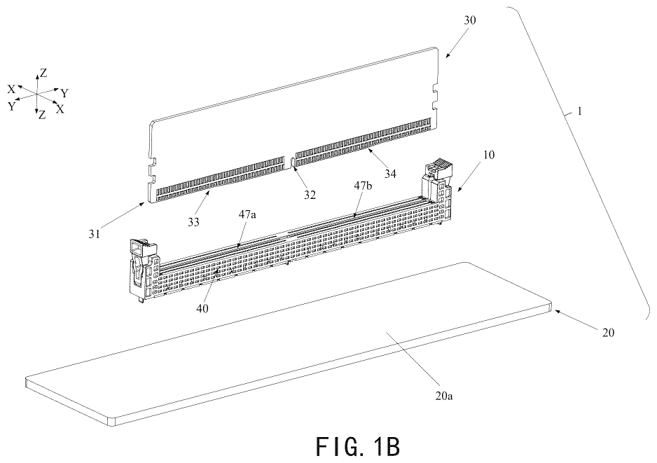

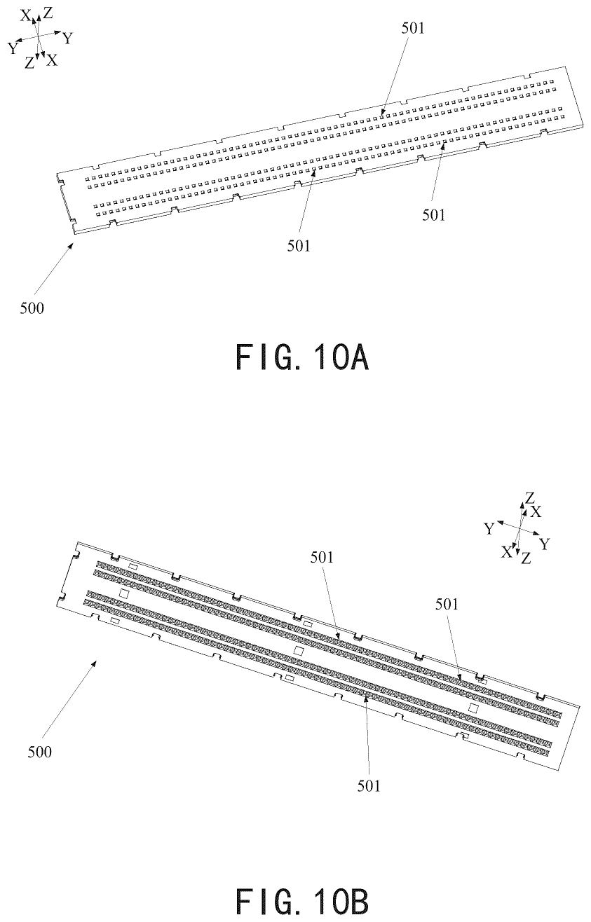

FIGS. 1A to 10B illustrate an electronic system 1 according to some embodiments of the present application. The electronic system 1 includes an electrical connector 10, a first circuit board 20, and a second circuit board 30. The electrical connector 10 is configured to establish an electrical connection between the first circuit board 20 and the second circuit board 30. For the sake of clarity and conciseness of description, a lateral direction X-X, a longitudinal direction Y-Y, and a vertical direction Z-Z may be shown in FIGS. 1A-10B. The lateral direction X-X, the longitudinal direction Y-Y, and the vertical direction Z-Z are perpendicular to each other. The lateral direction X-X may refer to a width direction of the electrical connector 10. The longitudinal direction Y-Y may refer to a length direction of the electrical connector 10. The vertical direction Z-Z may refer to a height direction of the electrical connector 10.

In some embodiments, the electrical connector 10 may be configured as a memory card connector used in a computer device. In this case, the first circuit board 20 may be a motherboard of the computer device, and the second circuit board 30 may be a memory card or module. For example, the second circuit board 30 may be a dual in-line memory module (DIMM) or any memory card or module manufactured according to a DDR standard, such as DDR4, DDR5, or DDR6. The electrical connector 10 may be capable of providing an interface that meets DDR specifications of DDR4, DDR5, DDR6, and higher performance requirements. The electrical connector 10 may also be referred to as “a card edge connector”. The electrical connector design technology according to the present application will be described below by taking such an electrical connector as an example, but it should be appreciated that the specific application of the present application is not limited thereto.

The first circuit board 20 may also be referred to as “a motherboard,” and may include a surface 20a and a plurality of conductive pads (not shown) disposed on the surface 20a. It is contemplated that the plurality of conductive pads may be disposed on the surface 20a in a plurality of pad rows (four pad rows in this embodiment, which will be described in detail below) extending respectively in the longitudinal direction Y-Y and spaced apart from each other. The plurality of conductive pads may be adapted to be attached with solder balls when a Ball Grid Array (BGA) packaging technique is used to mount the electrical connector 10 to the first circuit board 20, thereby establishing electrical connections with the conductive terminals of the electrical connector 10, as will be described in detail below. Each conductive pad may have a circular shape. However, it should be appreciated that the shape of the conductive pad is not limited thereto, and may have other shapes, such as a square or oval shape. It should also be appreciated that only a part, but not all, of the first circuit board 20 is shown schematically in the figures, and the specific type of the first circuit board 20 is not limited thereto.

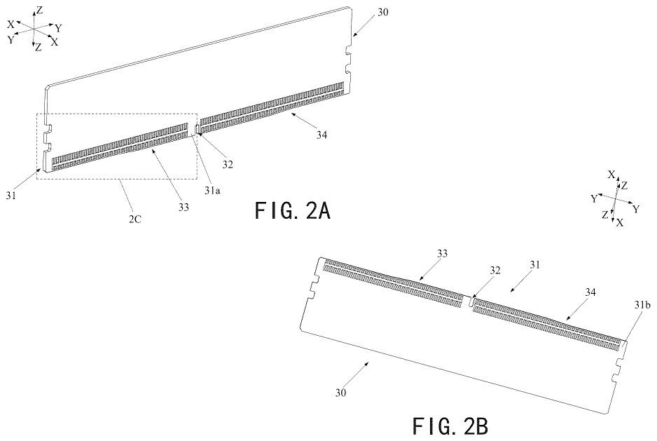

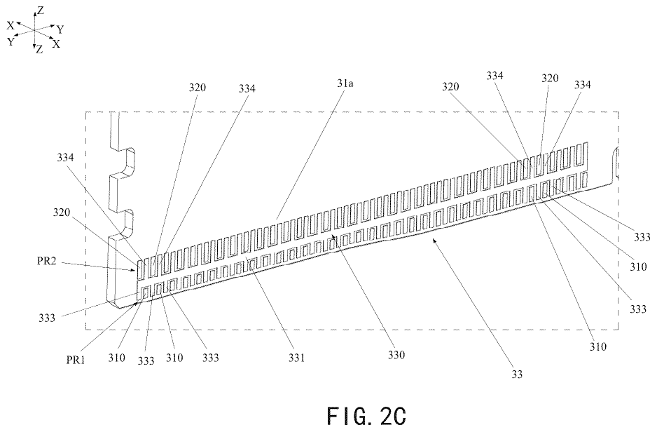

The second circuit board 30 may also be referred to as “a card” or “add-in card”. As shown in FIGS. 1B to 2C, the second circuit board 30 may include an edge portion 31. The edge portion 31 is configured to be inserted into the electrical connector 10 in the vertical direction Z-Z. The vertical direction Z-Z may also be referred to as “an insertion direction” or “mating direction”. The edge portion 31 may include a first surface 31a and a second surface 31b opposite to each other in the lateral direction X-X perpendicular to the vertical direction Z-Z. The edge portion 31 may further include contact pads disposed on the first surface 31a and the second surface 31b for establishing electrical connections with the conductive terminals of the electrical connector 10, as will be described in detail below. A notch 32 may be recessed into the second circuit board 30 from a front edge of the edge portion 31 in the vertical direction Z-Z to divide the edge portion 31 into a first subportion 33 and a second subportion 34. The first subportion 33 and the second subportion 34 are separated by the notch 32 in the longitudinal direction Y-Y perpendicular to the vertical direction Z-Z and the lateral direction X-X. The first subportion 33 and the second subportion 34 may be configured to be inserted into respective sections of the slot of the electrical connector 10, as will be described in detail below. The length of the first subportion 33 in the longitudinal direction Y-Y may be different from the length of the second subportion 34 in the longitudinal direction Y-Y to provide a fool-proof design, thereby ensuring that the second circuit board 30 is inserted into the electrical connector 10 in a unique direction. Further, an intermediate portion of the edge portion 31 in the longitudinal direction Y-Y may protrude slightly relative to two end portions of the edge portion 31 opposite to each other in the longitudinal direction Y-Y, and the front edge of the edge portion 31 may smoothly transition from the intermediate portion to the two end portions. For example, the shape of the edge portion 31 is configured to be slightly protruded in the middle and retracted at the two ends. Such a configuration can reduce friction when inserting and pulling the second circuit board 30 into and out of the electrical connector 10, thereby improving user experience. It should be appreciated that in some other embodiments, the front edge of the edge portion 31 may be straight. It should also be appreciated that only a part, but not all, of the second circuit board 30 is shown schematically in the figures, and the specific type of the second circuit board 30 is not limited thereto.

As shown in FIG. 1A, the electrical connector 10 may be mounted to the first circuit board 20 on the surface 20a of the first circuit board 20, and the second circuit board 30 may be inserted into the electrical connector 10. The electrical connector 10 may be secured on the first circuit board 20. As will be described in detail below, the tail ends of the conductive terminals of the electrical connector 10 may be soldered to the conductive pads on the surface 20a of the first circuit board 20, and the mating ends of the conductive terminals may be in contact with (e.g., establish separable connections with) the contact pads on the edge portion 31 of the second circuit board 30. In this way, the electrical connector 10 can mechanically and electrically connect the second circuit board 30 to the first circuit board 20, thereby establishing an electrical connection between the first circuit board 20 and the second circuit board 30.

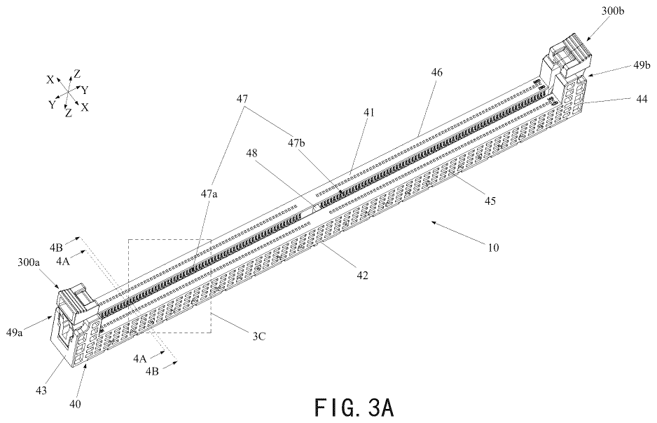

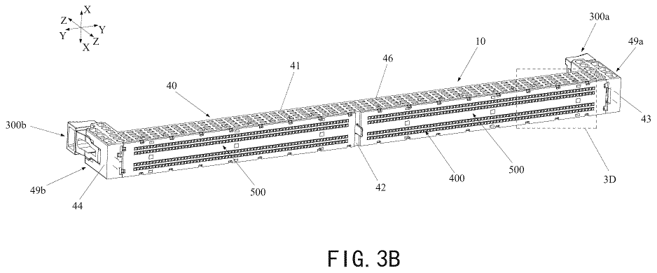

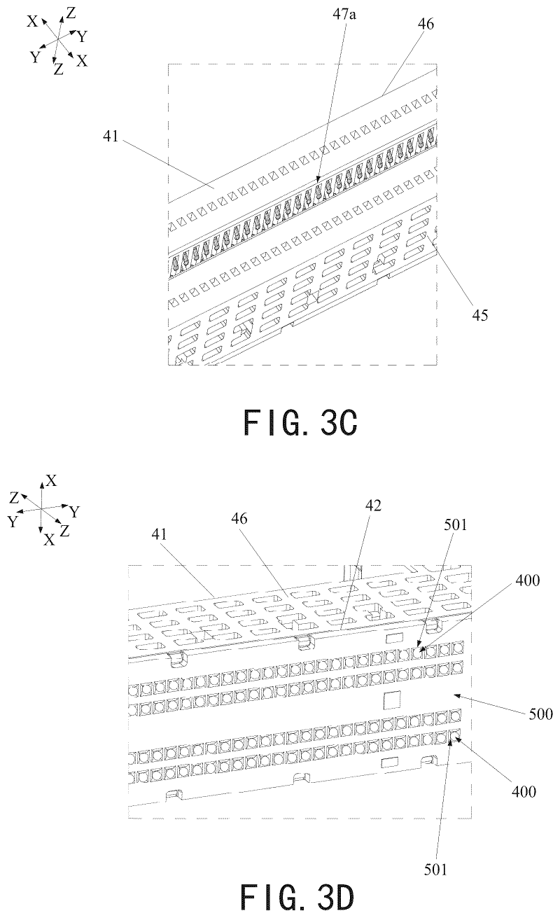

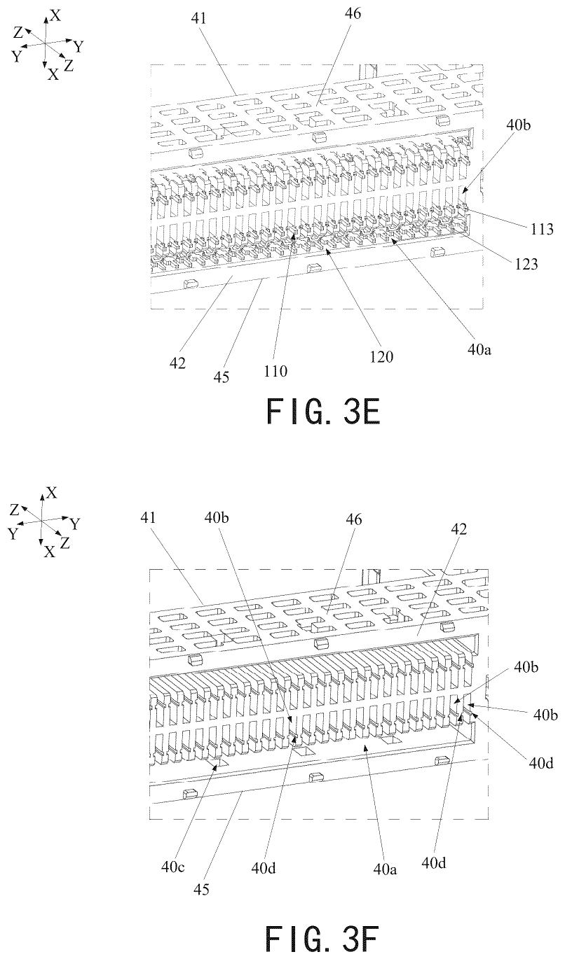

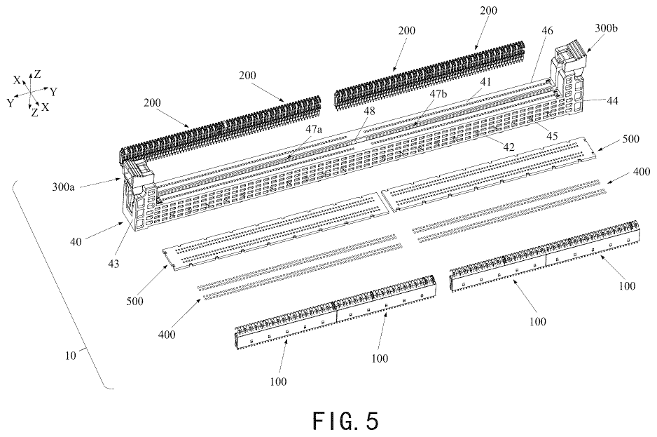

FIGS. 3A to 10B illustrate the detailed configurations of the electrical connector 10. As shown in FIG. 5, the electrical connector 10 includes an insulative housing 40 and a plurality of first terminal groups 100 (four in this embodiment) and a plurality of second terminal groups 200 (four in this embodiment) disposed in the insulative housing 40. The insulative housing 40 may be formed from an insulative material. Examples of insulative materials suitable for forming the insulative housing 40 include, but are not limited to, plastic, nylon, liquid crystal polymer (LCP), polyphenylene sulfide (PPS), high temperature nylon or polyphenylene oxide (PPO) or polypropylene (PP). Each of the first terminal groups 100 and the second terminal groups 200 may include a plurality of conductive terminals, each configured for establishing an electrical connection between a corresponding conductive pad of the first circuit board 20 and a corresponding contact pad of the second circuit board 30, as will be described in detail below. The conductive terminals may be formed from a conductive material. The conductive material suitable for forming the conductive terminals may be a metal material, such as a copper or copper alloy.

As shown in FIGS. 3A, 3B, and 5, the insulative housing 40 may include a first face 41 and a second face 42 opposite to each other in the vertical direction Z-Z, a third face 43 and a fourth face 44 opposite to each other in the longitudinal direction Y-Y, a fifth face 45 and a sixth face 46 opposite to each other in the lateral direction X-X, and a slot 47 recessed into the insulative housing 40 in the vertical direction Z-Z from the first face 41. The slot 47 is elongated in the longitudinal direction Y-Y. The insulative housing 40 may also include a separation portion 48 that separates the slot 47 into a first section 47a and a second section 47b spaced apart from each other. The first section 47a and the second section 47b may be separated by the separation portion 48 in the longitudinal direction Y-Y. The separation portion 48 may be an integral part of the insulative housing 40. The slot 47 is configured to receive the edge portion 31 of the second circuit board 30. The first section 47a and the second section 47b may be configured to receive the first subportion 33 and the second subportion 34 of the edge portion 31, respectively. The separation portion 48 may cooperate with the notch 32 of the edge portion 31 to guide the edge portion 31 to be inserted into the slot 47. The edge portion 31 of the second circuit board 30 is configured to be inserted into the insulative housing 40 from an entrance of the slot 47 at the first face 41. Thus, the first face 41 may also be referred to as “a mating face”. As will be described in detail below, the tail ends of the conductive terminals may protrude from the second face 42 of the insulative housing 40 in the vertical direction Z-Z for mounting to corresponding conductive pads on the first circuit board 20. Thus, the second face 42 may also be referred to as “a mounting face”. The mounting face and the mating face may be parallel to each other. The direction in which the slot 47 is recessed into the insulative housing 40 or to which the mating face is facing (here the vertical direction Z-Z) may be referred to as “a mating direction”. The direction to which the mounting face faces may be referred to as “a mounting direction”. In this embodiment, the mating direction and the mounting direction are parallel to each other. Thus, the electrical connector 10 is a vertical card edge connector. However, it should be appreciated that the present application is not limited thereto. In some other embodiments, the mounting face and the mating face may be perpendicular to each other, and the mating direction and the mounting direction may be perpendicular to each other. In this case, the electrical connector is a right angle card edge connector. Furthermore, although the insulative housing 40 is shown as including two slot sections, in some other embodiments, the insulative housing 40 may have a single slot section or more than two slot sections.

The insulative housing 40 may further include a first tower portion 49a and a second tower portion 49b extending from the first face 41 in the vertical direction Z-Z. The first tower portion 49a and the second tower portion 49b may be adjacent to the third face 43 and the fourth face 44, respectively, For example, adjacent to two end portions of the insulative housing 40 opposite to each other in the longitudinal direction Y-Y. The first tower portion 49a and the second tower portion 49b may bound a receiving space therebetween. The electrical connector 10 may further include a first latch 300a and a second latch 300b mounted in the first tower portion 49a and the second tower portion 49b, respectively. As shown in FIG. 1A, when the second circuit board 30 is inserted into the electrical connector 10, the second circuit board 30 may be received in the receiving space between the first tower portion 49a and the second tower portion 49b, the first subportion 33 and the second subportion 34 of the edge portion 31 of the second circuit board 30 are respectively inserted into the first section 47a and the second section 47b of the slot 47, and the first latch 300a and the second latch 300b respectively engage with two side edges of the second circuit board 30 opposite to each other in the longitudinal direction Y-Y, thereby reliably locking the second circuit board 30 in position relative to the electrical connector 10. It should be appreciated that the configurations of the electrical connector 10 are not limited thereto. In some other embodiments, the electrical connector 10 may be devoid of the first tower portion 49a, the second tower portion 49b, the first latch 300a, and the second latch 300b. Alternatively, the electrical connector 10 may have other types of locking mechanisms.

As shown in FIG. 5, four first terminal groups 100 and four second terminal groups 200 may be disposed in the insulative housing 40. Each of the four first terminal groups 100 and a corresponding one of the four second terminal groups 200 are spaced apart from each other across the slot 47 in the lateral direction X-X. For example, four sets of terminal groups may be disposed in the insulative housing 40, and each set includes one first terminal group 100 and one second terminal group 200. The first terminal group 100 of each set is disposed on one side of the slot 47 in the lateral direction X-X, and the second terminal group 200 is disposed on the other side of the slot 47 in the lateral direction X-X. Each set of terminal groups may be configured to contact with corresponding contact pads on the first surface 31a and the second surface 31b of the edge portion 31 when the second circuit board 30 is inserted into the electrical connector 10, thereby establishing electrical connections between the electrical connector 10 and the second circuit board 30.

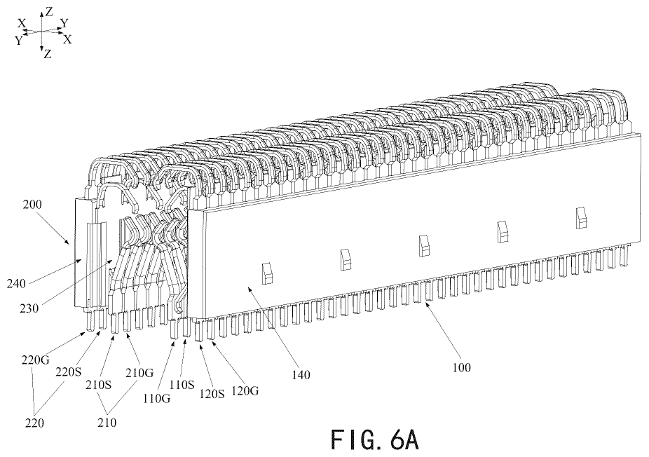

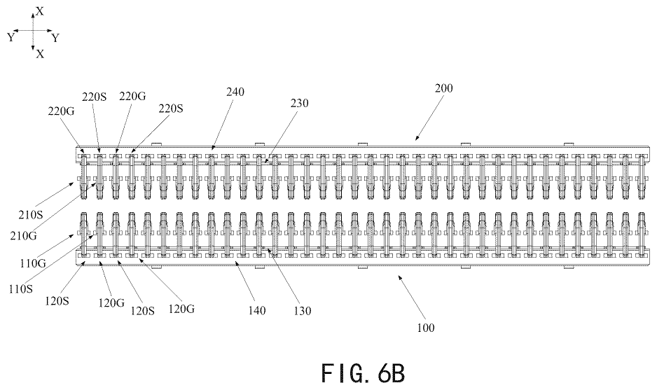

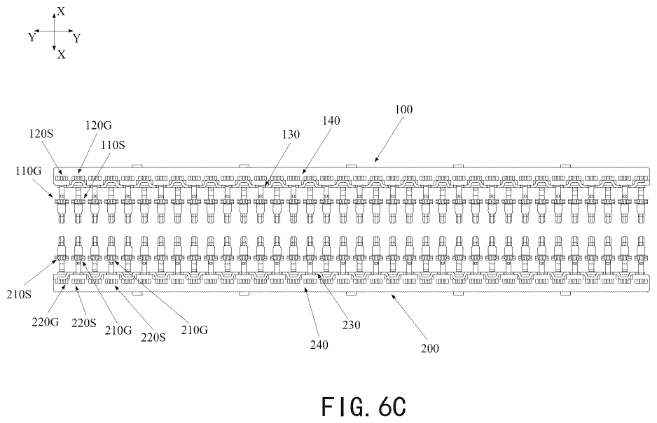

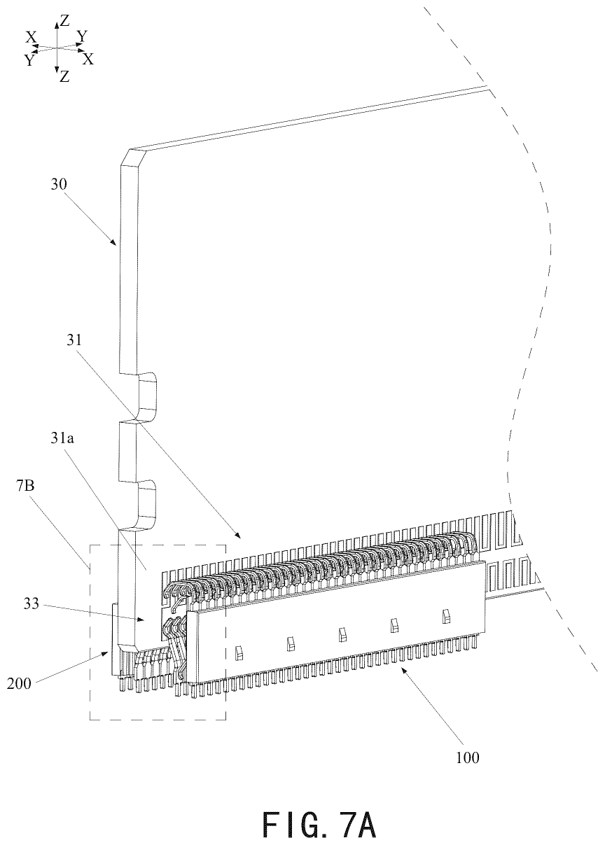

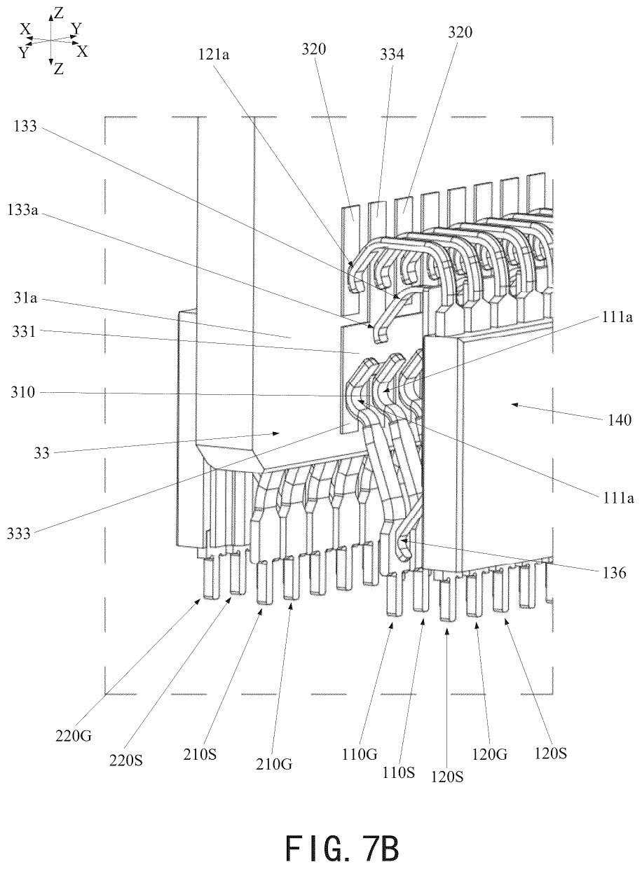

The detailed configuration of the terminal groups of the electrical connector 10 will be described below in connection with the set of terminal groups disposed in the first section 47a of the slot 47. FIGS. 6A to 7B illustrate the detailed configurations of such a set of terminal groups. FIGS. 6A to 6C are perspective, top and bottom views, respectively, of the set of terminal groups, but with the insulative housing 40 removed to show the relative positional relationship of the set of terminal groups when assembled in the insulative housing 40. FIGS. 7A and 7B illustrate the relative positional relationship of the set of terminal groups relative to the second circuit board 30 when the second circuit board 30 is inserted in the electrical connector 10.

As shown in FIGS. 6A to 7B, the set of terminal groups includes one first terminal group 100 and one second terminal group 200. The first terminal group 100 and the second terminal group 200 may be disposed in the insulative housing 40. The first terminal group 100 and the second terminal group 200 are opposing to and spaced apart from each other in the lateral direction X-X across the first section 47a of the slot 47. The first terminal group 100 is disposed on one side of the first section 47a in the lateral direction X-X, and the second terminal group 200 is disposed on the other side of the first section 47a in the lateral direction X-X. The first terminal group 100 may have no portion disposed on the other side of the first section 47a in the lateral direction X-X, and the second terminal group 200 may have no portion disposed on the side of the first section 47a in the lateral direction X-X. When the second circuit board 30 is inserted into the electrical connector 10, the first terminal group 100 and the second terminal group 200 may be in contact with corresponding contact pads on the first surface 31a and the second surface 31b of the first subportion 33 of the edge portion 31, respectively, thereby establishing electrical connections between the electrical connector 10 and the second circuit board 30.

The configurations of the first terminal group 100 may be similar to those of the second terminal group 200. In some embodiments, the configurations of the first terminal group 100 may be symmetrical with those of the second terminal group 200. For example, the configurations of the first terminal group 100 and the configurations of the second terminal group 200 may be 180°-rotationally symmetric about an axis extending in the vertical direction Z-Z and through the midpoint of the slot section between the first terminal group 100 and the second terminal group 200. As another example, the configuration of the first terminal group 100 and the configuration of the second terminal group 200 may be mirror symmetric about the longitudinal centerline of the slot section between the first terminal group 100 and the second terminal group 200.

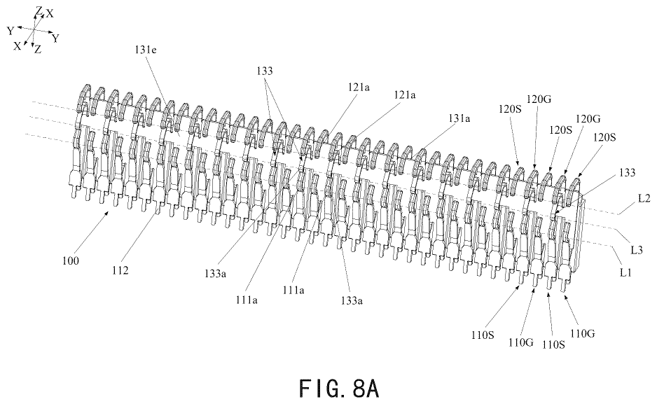

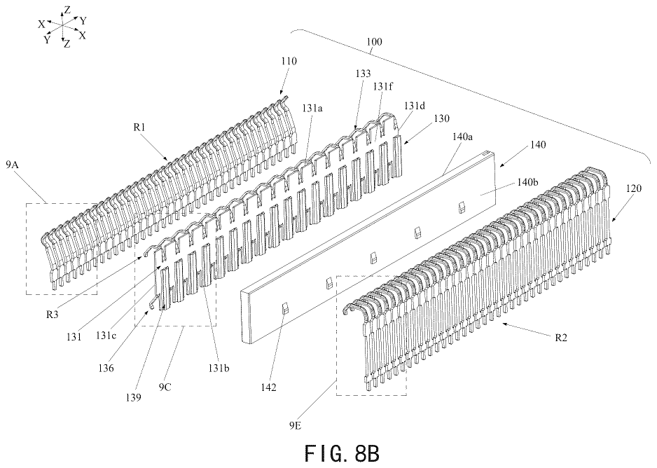

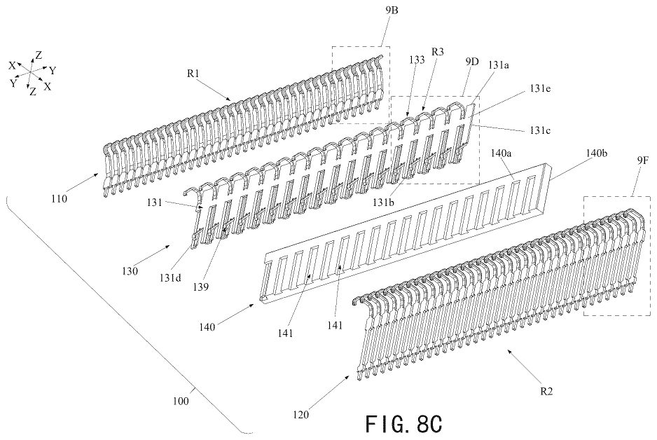

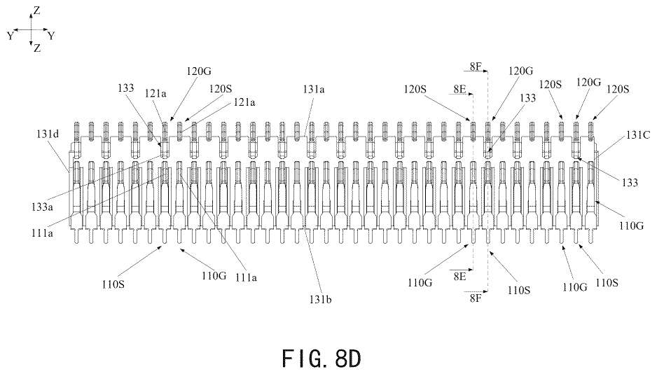

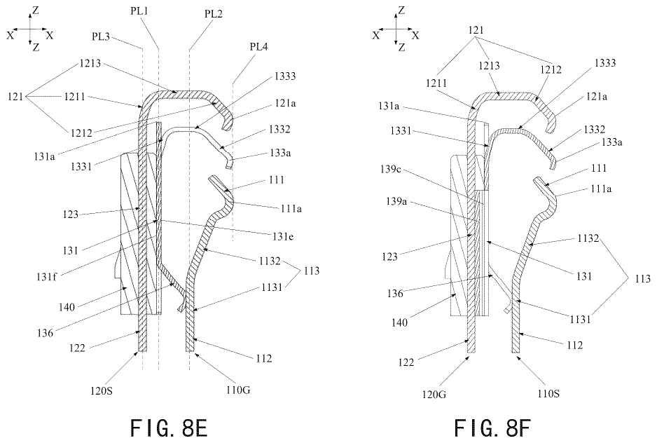

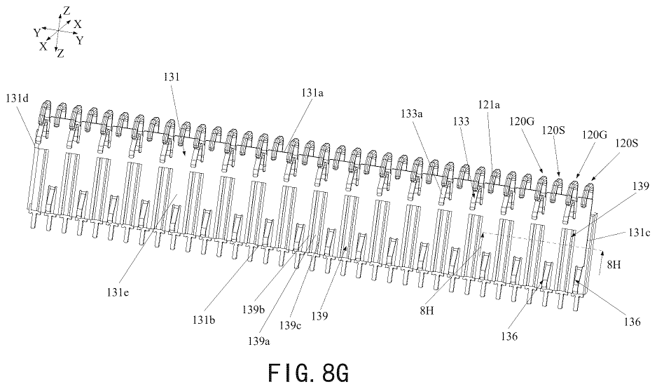

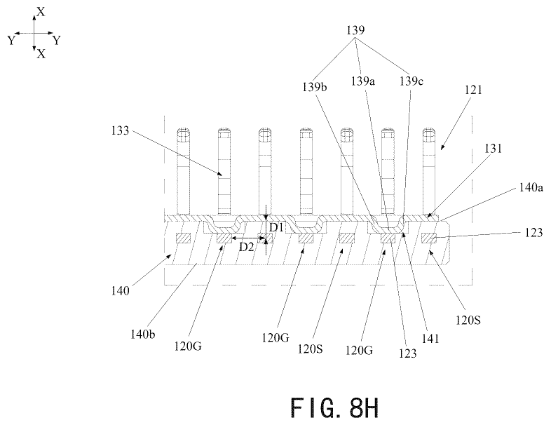

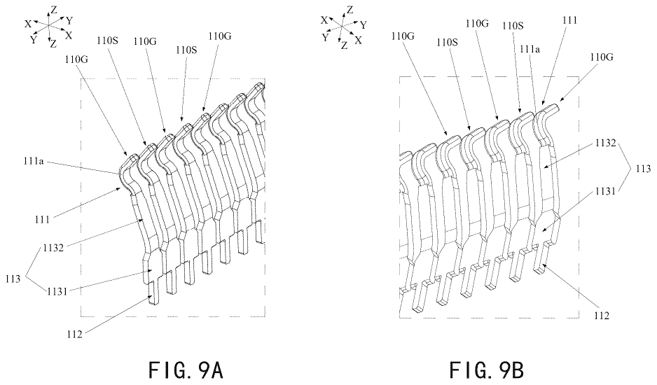

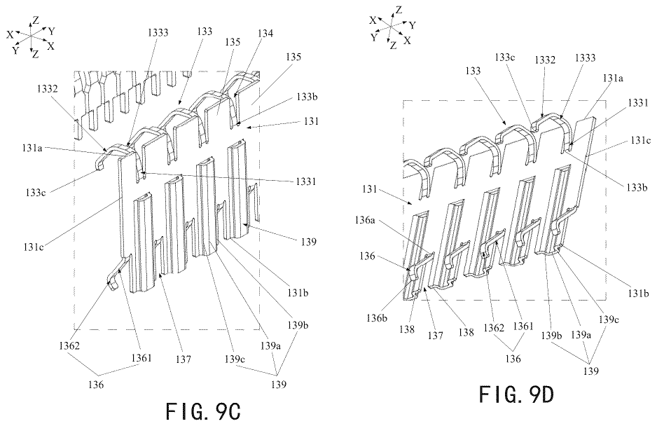

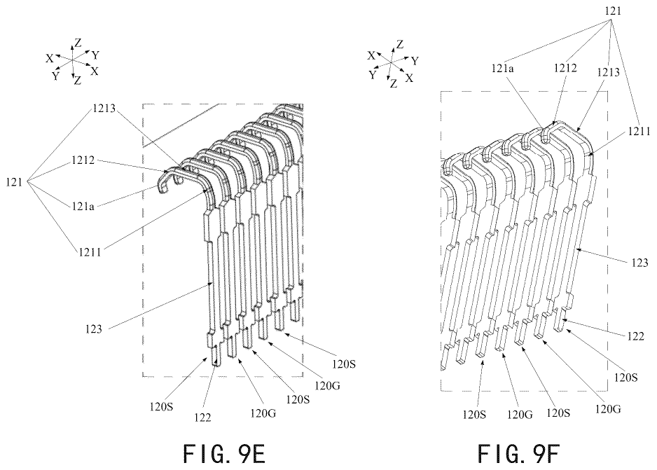

The detailed configurations of the first terminal group 100 will be described below with reference to FIG. 8A to FIG. 9F. As shown in FIGS. 8B and 8C, the first terminal group 100 may include a plurality of first conductive terminals 110, a plurality of second conductive terminals 120, and a conductive member 130.

As shown in FIGS. 8A to 8D, the plurality of first conductive terminals 110 are disposed in a first row R1 in the longitudinal direction Y-Y. The first conductive terminals 110 of the first row R1 are aligned with and spaced apart from each other in the longitudinal direction Y-Y. The plurality of first conductive terminals 110 may include first signal terminals 110S and first ground terminals 110G. The first signal terminals 110S include a plurality of signal terminal subsets, with a single first signal terminal 110S as a subset and/or with a pair of first signal terminals 110S as a subset, and the first ground terminals 110G are disposed between adjacent subsets of the plurality of signal terminal subsets to separate the plurality of signal terminal subsets from each other. A ground terminal may be disposed between every two adjacent signal terminal subsets. The signal terminal subset having a single first signal terminal 110S may be configured to transmit a high-speed signal, such as a single-ended signal. The signal terminal subset having a pair of first signal terminals 110S may be configured to transmit differential signals. In this case, one of the pair of first signal terminals 110S may be energized by a first voltage and the other may be energized by a second voltage. The voltage difference between the pair of first signal terminals 110S represents a signal. Separating the plurality of signal terminal subsets from each other with the first ground terminals 110G can reduce crosstalk and thus improve signal integrity. The signal terminal subset may have more than two first signal terminals 110S.

The plurality of first conductive terminals 110 (the first signal terminals 110S and the first ground terminals 110G) may have the same configurations. As shown in FIGS. 9A and 9B, each of the plurality of first conductive terminals 110 includes a first mating end 111, a first tail end 112 opposite to the first mating end 111, and a first intermediate portion 113 extending between the first mating end 111 and the first tail end 112. The first intermediate portion 113 joins the first mating end 111 and the first tail end 112. The first mating end 111 is configured to establish an electrical connection with a corresponding contact pad on the first surface 31a of the first subportion 33 of the edge portion 31 when the second circuit board 30 is inserted into the electrical connector 10. The first mating end 111 has a first mating contact portion 111a configured to curve into the first section 47a of the slot 47 to contact with a corresponding contact pad of the second circuit board 30. The first tail end 112 is located at least partially outside of the insulative housing 40 for establishing an electrical connection with a corresponding conductive pad on the surface 20a of the first circuit board 20.

As shown in FIGS. 8A to 8D, the plurality of second conductive terminals 120 are disposed in a second row R2 in the longitudinal direction Y-Y. The second conductive terminals 120 of the second row R2 are aligned with and spaced apart from each other in the longitudinal direction Y-Y. The plurality of second conductive terminals 120 may include second signal terminals 120S and second ground terminals 120G. Similar to the first row R1, in the second row R2, the second signal terminals 120S may include a plurality of signal terminal subsets, with a single second signal terminal 120S as a subset and/or a pair of second signal terminals 120S as a subset, and the second ground terminals 120G are disposed between adjacent subsets of the plurality of signal terminal subsets to separate the plurality of signal terminal subsets from each other. A ground terminal may be disposed between every two adjacent signal terminal subsets. Details of the similar parts may not be repeated.

The plurality of second conductive terminals 120 (the second signal terminals 120S and the second ground terminals 120G) may have the same configurations. As shown in FIGS. 9E and 9F, each of the plurality of second conductive terminals 120 includes a second mating end 121, a second tail end 122 opposite to the second mating end 121, and a second intermediate portion 123 extending between the second mating end 121 and the second tail end 122. The second intermediate portion 123 joins the second mating end 121 and the second tail end 122. The second mating end 121 is configured to establish an electrical connection with a corresponding contact pad on the first surface 31a of the first subportion 33 of the edge portion 31 when the second circuit board 30 is inserted into the electrical connector 10. The second mating end 121 has a second mating contact portion 121a configured to curve into the first section 47a of the slot 47 to contact with a corresponding contact pad of the second circuit board 30. The second tail end 122 is located at least partially outside of the insulative housing 40 for establishing an electrical connection with a corresponding conductive pad on the surface 20a of the first circuit board 20.

As shown in FIGS. 8A, 8E, and 8F, the first row R1 and the second row R2 are opposing to and spaced apart from each other in the lateral direction X-X. The first row R1 and the second row R2 are disposed on the same side of the slot 47 in the lateral direction X-X. The first conductive terminals 110 of the first row R1 and the second conductive terminals 120 of the second row R2 are configured to establish electrical connections with corresponding contact pads on the same side (e.g., the first surface 31a) of the edge portion 31 of the second circuit board 30. Such a configuration of the electrical connector 10 according to the present application can provide conductive terminals on the same side of the slot 47 with double density as compared to conventional card edge connectors having only a single row of terminals on the same side of the slot.

The conductive member 130 is configured to be electrically coupled to the first ground terminal(s) 110G and the second ground terminal(s) 120G. For example, the conductive member 130 may electrically couple the first ground terminal(s) 110G and the second ground terminal(s) 120G together. The electrical coupling may be direct contact or capacitive coupling, as will be described in detail below. In some embodiments, as shown in FIGS. 8A to 8F, the conductive member 130 may be disposed between the first row R1 and the second row R2 and electrically coupled to the first ground terminal(s) 110G of the first row R1 and the second ground terminal(s) 120G of the second row R2. It should be appreciated that the first ground terminal(s) 110G of the first row R1 may be all or a selected number of the first ground terminal(s) 110G of the first row R1, and the second ground terminal(s) 120G of the second row R2 may be all or a selected number of the second ground terminal(s) 120G of the second row R2.

Such a configuration of the electrical connector 10 can maintain or improve signal integrity while providing a higher terminal density, enabling the electrical connector 10 to operate at a higher speed and have a greater number of terminals to provide more independent signal paths. With such a configuration, the insertion loss (IL) and return loss (RL) of signals passing through the electrical connector 10 may be reduced, thereby maintaining or improving signal integrity with a higher terminal density. Furthermore, with such a configuration, a conductive path can be provided between the first ground terminal(s) 110G of the first row R1 and the second ground terminal(s) 120G of the second row R2 to eliminate the potential difference between these ground terminals as much as possible, and can reduce the affect of crosstalk, thereby maintaining or improving signal integrity while providing a higher terminal density. Such a configuration may enable the electrical connector 10 to meet the performance requirements specified by DDR4, DDR5, DDR6, or higher DDR standards while providing a higher terminal density.

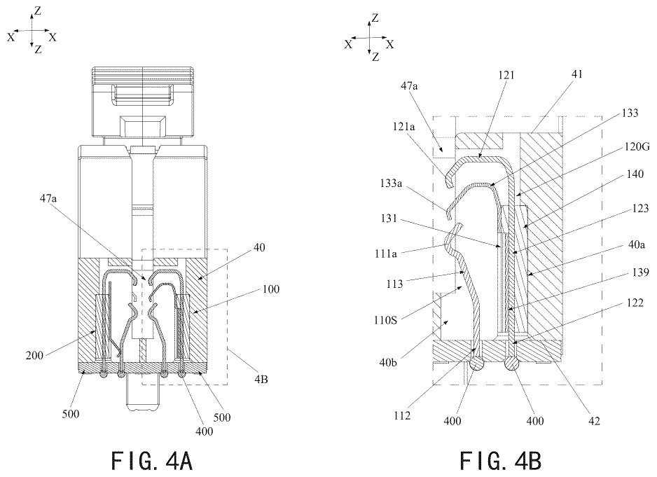

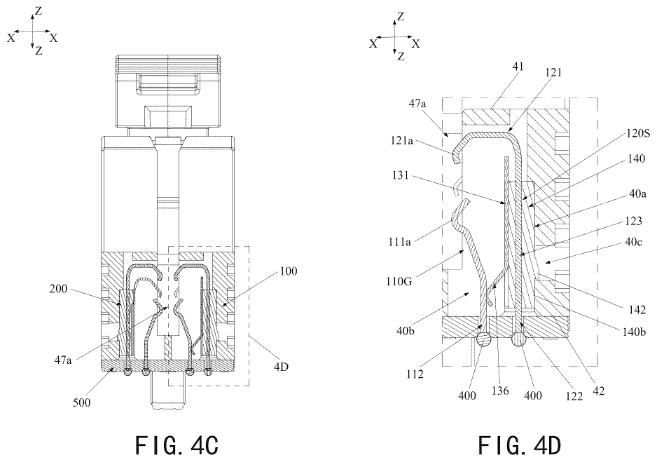

As shown in FIGS. 4A to 4D, the first row R1 may be closer to the slot 47 than the second row R2 in the lateral direction X-X. The first mating contact portions 111a of the first mating ends 111 of the first conductive terminals 110 of the first row R1 curve into the first section 47a of the slot 47, and the second mating contact portions 121a of the second mating ends 121 of the second conductive terminals 120 of the second row R2 are also curved into the first section 47a of the slot 47. For example, the first mating contact portions 111a and the second mating contact portions 121a curve into the same slot 47.

In some embodiments, as shown in FIGS. 8B, 8C, 9E, and 9F, the conductive member 130 may include a plurality of first resilient beams (or resilient arms) 133 disposed in a third row R3 in the longitudinal direction Y-Y. The first resilient beams 133 of the third row R3 are aligned with and spaced apart from each other in the longitudinal direction Y-Y. Each first resilient beam 133 is configured to establish an electrical connection with a corresponding contact pad (here a ground contact pad, as will be described in detail below) on the first surface 31a of the first subportion 33 of the edge portion 31 when the second circuit board 30 is inserted into the electrical connector 10. Each first resilient beam 133 has a third mating contact portion 133a configured to curve into the first section 47a of the slot 47 (FIGS. 4A to 4D) to contact with a corresponding contact pad of the second circuit board 30.

With such a configuration, the first mating contact portions 111a of the plurality of first conductive terminals 110, the second mating contact portions 121a of the plurality of second conductive terminals 120, and the third mating contact portions 133a of the plurality of first resilient beams 133 curve into the slot 47 on the same side of the slot 47 and are configured to contact with corresponding conductive pads on the same side of the edge portion 31 of the second circuit board 30 when the edge portion 31 is received in the slot 47.

As shown in FIG. 8A, the first mating contact portions 111a of the first mating ends 111 of the plurality of first conductive terminals 110 may be aligned in a first line L1, and the second mating contact portions 121a of the second mating ends 121 of the plurality of second conductive terminals 120 may be aligned in a second line L2. In some embodiments, the second line L2 may be parallel to the first line L1 and spaced apart from the first line L1 in the vertical direction Z-Z. The third mating contact portions 133a of the plurality of first resilient beams 133 may be aligned in the third line L3. The third line L3 may also be parallel to the first line L1. Thus, the first line L1, the second line L2, and the third line L3 may be parallel to each other. The first line L1, the second line L2, and the third line L3 are imaginary lines. The third line L3 may be located between the first line L1 and the second line L2 in the vertical direction Z-Z. The first line L1, the second line L2, and the third line L3 may be spaced apart from each other in the vertical direction Z-Z, for example, spaced apart from each other with a uniform spacing. The second line L2 may be closer to the first face 41 (e.g., the mating face) than the first line L1 in the vertical direction Z-Z. In other words, the second mating contact portions 121a may be closer to the entrance of the slot 47 than the first mating contact portions 111a. Disposing the third row R3 (the plurality of first resilient beams 133) between the first row R1 (the plurality of first conductive terminals 110) and the second row R2 (the plurality of second conductive terminals 120) can reduce crosstalk, thereby improving signal integrity.

In some embodiments, the first line L1, the second line L2, and the third line L3 may be parallel to the longitudinal direction Y-Y, respectively. The first line L1, the second line L2, and the third line L3 may be coplanar in a plane PL4 perpendicular to the lateral direction X-X (FIG. 8E). Such a configuration can provide sufficient contact force between the first mating contact portions 111a, the second mating contact portions 121a, and the third mating contact portions 133a and the corresponding contact pads of the edge portion 31 of the second circuit board 30 when the edge portion 31 is inserted into the slot 47 to ensure stable electrical contact therebetween, while reducing the friction force of plugging and pulling the second circuit board 30 into and out of the electrical connector 10.

As shown in FIGS. 8B, 8C, 8E, 8F, 9C, and 9D, the conductive member 130 further includes a body 131. Each first resilient beam 133 extends from the body 131. The body 131 may have a plate shape. The conductive member 130 may also be referred to as “a shield”. The body 131 may extend in a first main plane PL1 (which is shown in dashed lines in FIG. 8E) perpendicular to the lateral direction X-X and between the first row R1 and the second row R2. The body 131 may include a first edge (or upper edge) 131a and a second edge (or lower edge) 131b opposite to each other in the vertical direction Z-Z, a third edge 131c and a fourth edge 131d opposite to each other in the longitudinal direction Y-Y, and a first face 131e and a second face 131f opposite to each other in the lateral direction X-X. The first edge 131a of the first body 131 is closer to the first face 41 than the second edge 131b. The body 131 may be continuous in the longitudinal direction Y-Y and the vertical direction Z-Z. The face of the body 131 may also be referred to as the “surface” or “broadside” of the body 131, and the edge of the body 131 may also be referred to as the “narrow side” of the body 131. As shown in FIG. 8E, the first main plane PL1 may be centered between the first face 131e and the second face 131f and parallel to the first face 131e and the second face 131f. The first main plane PL1 may be bounded by a main extension direction of the body 131. The first main plane PL1 is an imaginary plane. The first main plane PL1 may also be referred to as the “center plane” or “extension plane” of the body 131.

As shown in FIGS. 8B and 8C, for the first row R1, the first intermediate portions 113 of the plurality of first conductive terminals 110 may be aligned with and spaced apart from each other in the longitudinal direction Y-Y, and the first mating ends 111 may be aligned with and spaced apart from each other in the longitudinal direction Y-Y. For the second row R2, the second intermediate portions 123 of the second conductive terminals 120 may be aligned with and spaced apart from each other in the longitudinal direction Y-Y, and the second mating ends 121 may be aligned with and spaced apart from each other in the longitudinal direction Y-Y. As shown in FIGS. 8A and 8D to 8F, for each first conductive terminal 110, the first intermediate portion 113 and the first mating end 111 are located on a first side of the body 131 adjacent to the slot 47 (e.g., the first section 47a) in the lateral direction X-X. Thus, the first mating contact portion 111a of the first mating end 111 are also located on the first side of the slot 47. For each second conductive terminal 120, the second intermediate portion 123 is located on a second side of the body 131 opposite to the first side in the lateral direction X-X (e.g., the side of the body 131 away from the slot 47), and the second mating end 121 extends from the second intermediate portion 123 on the second side and extends over the first edge 131a of the body 131 of the conductive member 130 to the first side so that the second mating contact portion 121a is located on the first side.

With such a configuration, the first mating contact portions 111a of the plurality of first conductive terminals 110 and the second mating contact portions 121a of the plurality of second conductive terminals 120 are all located on the first side of the body 131 adjacent to the slot 47 in the lateral direction X-X. The body 131 is located between (i) the first mating ends 111 and the first intermediate portions 113 of the plurality of first conductive terminals 110 and (ii) the second intermediate portions 123 of the plurality of second conductive terminals 120. The first face 131e of the body 131 faces toward the first mating ends 111 and the first intermediate portions 113 of the plurality of first conductive terminals 110, and the second face 131f faces toward the second intermediate portions 123 of the plurality of second conductive terminals 120. The body 131 may provide shielding between (i) the first mating ends 111 and the first intermediate portions 113 of the first signal terminals 110S of the first row R1 and (ii) the second intermediate portions 123 of the second signal terminals 120S of the second row R2.

In some embodiments, as shown in FIGS. 8C to 8F, 9E, and 9F, for each second conductive terminal 120, the second mating end 121 may be substantially inverted U-shaped. For example, the second mating end 121 may include a first segment 1211 extending from the second intermediate portion 123, a second segment 1212 forming the second mating contact portion 121a, and a third segment 1213 joining the first segment 1211 and the second segment 1212. The third segment 1213 forms a top of the inverted U-shape, and the first segment 1211 and the second segment 1212 form two legs of an inverted U-shape. The first segment 1211 extends from the second intermediate portion 123 on the second side toward the first face 41 (or toward the entrance of the slot 47) and beyond the first edge 131a of the body 131 of the conductive member 130. The third segment 1213 extends from the first segment 1211 over the first edge 131a of the body 131 to the first side. The second segment 1212 extends from the third segment 1213 away from the first face 41 and is convexly curved toward the slot 47, thereby forming the second mating contact portion 121a.

The second mating end 121 of each second conductive terminal 120 may bound an inverted U-shaped space when viewed in the longitudinal direction Y-Y. The opening of the U-shaped space faces away from the first face 41 of the insulative housing 40. In some embodiments, the first edge 131a of the body 131 of the conductive member 130 may extend into the inverted U-shaped space in the vertical direction Z-Z. For example, the first edge 131a of the body 131 may extend into the inverted U-shaped space bounded by the second mating end 121 of the second signal terminal 120S in the vertical direction Z-Z. In some embodiments, the second mating contact portion 121a of each second conductive terminal 120 may be located inwardly of the first edge 131a of the body 131 in the vertical direction Z-Z. With such a configuration, it is possible to provide better shielding for the contact parts of the second conductive terminals 120 and corresponding contact pads of the second circuit board 30.

In some embodiments, for each second conductive terminal 120, the first segment 1211 is closer to the body 131 of the conductive member 130 than the second segment 1212 in the lateral direction X-X.

As shown in FIGS. 8C, 8E, 8F, and 9D, each of the plurality of first resilient beams 133 of the conductive member 130 extends from the body 131 toward the first side so that the third mating contact portion 133a is located on the first side. With such a configuration, the first mating contact portions 111a of the plurality of first conductive terminals 110, the second mating contact portions 121a of the plurality of second conductive terminals 120, and the third mating contact portions 133a of the plurality of first resilient beams 133 are all located on the first side of the body 131 adjacent to the slot 47 in the lateral direction X-X.

In some embodiments, as shown in FIGS. 8C, 8E, 8F, and 9D, each of the first resilient beams 133 may be substantially inverted U-shaped. For example, the first resilient beam 133 may include a first segment 1331 extending from the body 131, a second segment 1332 forming the third mating contact portion 133a, and a third segment 1333 joining the first segment 1331 and the second segment 1332. The third segment 1333 forms a top of the inverted U-shape, and the first segment 1331 and the second segment 1332 form two legs of the inverted U-shape. The first segment 1331 extends from the body 131 toward the first face 41 (in other words, toward the entrance of the slot 47). The second segment 1332 extends from the third segment 1333 away from the first face 41 and is convexly curved toward the slot 47, thereby forming the third mating contact portion 133a. In some embodiments, the first segment 1331 does not extend beyond the first edge 131a of the body 131 in the vertical direction Z-Z. Such a configuration can prevent the first resilient beam 133 from interfering with the deflection of the corresponding second conductive terminal 120 when the second conductive terminal 120 (specifically, the second ground terminal 120G, as will be described in detail below) is biased by the edge portion 31 of the second circuit board 30.

Each first resilient beam 133 may bound an inverted U-shaped space when viewed in the longitudinal direction Y-Y. The opening of the U-shaped space faces away from the first face 41 of the insulative housing 40. Thus, the first resilient beam 133 is contoured to substantially conform to the profile of the second mating end 121 of the second conductive terminal 120.

In some embodiments, as shown in FIGS. 8C, 8E, 8F, and 9D, the second mating end 121 of each second ground terminal 120G of the plurality of second conductive terminals 120 may be aligned with a corresponding one of the plurality of first resilient beams 133 in the vertical direction Z-Z.

In some embodiments, as shown in FIGS. 9C and 9D, each first resilient beam 133 may be a part integrally stamped from the body 131. The first resilient beam 133 may have a fixed end 133b and a free end 133c opposite to the fixed end 133b. The third mating contact portion 133a may be formed adjacent to the free end 133c. The first resilient beam 133 is connected to the body 131 at the fixed end 133b. The fixed end 133b may be indented into the body 131 in the vertical direction Z-Z relative to the first edge 131a of the body 131. As such, as shown in FIG. 9C, a plurality of cutouts 134 are formed in the portion of the body 131 adjacent to the first edge 131a. The portion of the body 131 is separated into a plurality of subportions 135 by the cutouts 134. Every adjacent two subportions 135 of the plurality of subportions 135 are separated by a corresponding cutout 134 in the longitudinal direction Y-Y. As will be described in detail below, each subportion 135 of the plurality of subportions 135 may be aligned with a corresponding subset of second signal terminals 120S (e.g., a single second signal terminal 120S or a pair of second signal terminals 120S forming a differential signal pair) in the lateral direction X-X. With such a configuration, it is possible to provide better shielding effect, thereby improving signal integrity.

In some embodiments, as shown in FIGS. 8A to 9B and 9E to 9F, in the first row R1, the first signal terminals 110S and the first ground terminals 110G may be alternately disposed in the longitudinal direction Y-Y, and in the second row R2, the second signal terminals 120S and the second ground terminals 120G may be alternately disposed in the longitudinal direction Y-Y. For example, in the first row R1, the first signal terminals 110S include a plurality of signal terminal subsets with a single first signal terminal 110S as a subset, and the first ground terminals 110G are disposed between adjacent subsets of the plurality of signal terminal subsets to separate the plurality of signal terminal subsets from each other. In the first row R1, the first signal terminals 110S and the first ground terminals 110G are disposed in a manner such as “G-S-G-S- . . . ” or “S-G-S-G- . . . ” (wherein G represents the second ground terminal 120G, and S represents the first signal terminal 110S), wherein one second ground terminal 120G is disposed between two adjacent first signal terminals 110S. In the second row R2, the second signal terminals 120S and the second ground terminals 120G may be disposed in a similar manner, and for the sake of brevity, the details of these portions will not be repeated. Each of the first signal terminals 110S and the second signal terminals 120S may be configured to transmit a high-speed signal, such as a single-ended signal.

In this embodiment, as shown in FIG. 8A, each first signal terminal 110S of the first row R1 is aligned with one corresponding second ground terminal 120G of the second row R2 in the lateral direction X-X, and each second signal terminal 120S of the second row R2 is aligned with one corresponding first ground terminal 110G of the first row R1 in the lateral direction X-X. For example, the first signal terminals 110S of the first row R1 are offset from the second signal terminals 120S of the second row R2 in the lateral direction X-X, and the first ground terminals 110G of the first row R1 are offset from the second ground terminals 120G of the second row R2 in the lateral direction X-X. Such a configuration may enable the first row R1 and the second row R2 to be disposed at a smaller spacing in the lateral direction X-X while still maintaining sufficient spacing between the first signal terminals 110S of the first row R1 and the second signal terminals 120S of the second row R2. Such a configuration may reduce the size of the first terminal group 100 in the lateral direction X-X. This facilitates miniaturization of the electrical connector 10 and can reduce the space of the electrical connector 10 occupied on the first circuit board 20.

In this embodiment, as shown in FIG. 8D, the first mating contact portion 111a of each first signal terminal 110S of the first row R1 may be aligned, in the vertical direction Z-Z, with the second mating contact portion 121 a of the corresponding second ground terminal 120G of the second row R2 and the third mating contact portion 133a of a corresponding one of the plurality of first resilient beams 133. The third mating contact portion 133a is located between the first mating contact portion 111a and the second mating contact portion 121a. For example, the corresponding first resilient beam 133 extends to a position between the first mating contact portion 111a of the first signal terminal 110S and the second mating contact portion 121a of the corresponding second ground terminal 120G. Further, the second mating contact portion 121 a of each second signal terminal 120S of the second row R2 is aligned, in the vertical direction Z-Z, with the first mating contact portion 111 a of the corresponding first ground terminal 110G of the first row R1. Such a configuration may reduce crosstalk so that the first row R1 and the second row R2 can be disposed further close to each other in the lateral direction X-X. Such a configuration may further reduce the size of the first terminal group 100 in the lateral direction X-X. This facilitates miniaturization of the electrical connector 10 and can reduce the space of the electrical connector 10 occupied on the first circuit board 20.

Although it has been described above that in each of the two terminal rows R1 and R2, the signal terminals include a plurality of signal terminal subsets with a single signal terminal as a subset, and the ground terminals are disposed between adjacent ones of the plurality of signal terminal subsets, it should be appreciated that in some other embodiments, the signal terminals may include a plurality of signal terminal subsets with a pair of signal terminals as a subset, and the ground terminals are disposed between adjacent ones of the plurality of signal terminal subsets. In this case, the ground terminal may have a sufficient width (e.g., equal to the width of the pair of signal terminals) to ensure that the signal terminals of the two rows are offset from each other in the lateral direction X-X. Each pair of signal terminals may be configured as a differential signal pair. In this case, the conductive member may still be configured to interconnect the ground terminals together to achieve the above advantages.

The conductive member 130 may include a plurality of first extensions each configured to electrically couple the body 131 to the first intermediate portion 113 of a corresponding first ground terminal 110G of the first row R1. For example, each first extension may be aligned with a corresponding first ground terminal 110G of the first row R1 in the lateral direction X-X, and extend from the body 131 toward the corresponding first ground terminal 110G to electrically couple with the first intermediate portion 113 of the corresponding first ground terminal 110G. Such electrical coupling may be direct contact or capacitive coupling. With such a configuration, the conductive member 130 may be electrically coupled to the first ground terminals 110G of the first row R1 through the plurality of first extensions, and electrically couple the first ground terminals 110G together through the body 131.

The conductive member 130 may include a plurality of second extensions, each configured to electrically couple the body 131 to the second intermediate portion 123 of a corresponding second ground terminal 120G of the second row R2. For example, each second extension may be aligned with a corresponding second ground terminal 120G of the second row R2 in the lateral direction X-X, and extend from the body 131 toward the second intermediate portion 123 of the corresponding second ground terminal 120G so as to be electrically coupled with the second intermediate portion 123. Such electrical coupling may be direct contact or capacitive coupling. With such a configuration, the conductive member 130 may be electrically coupled with the second ground terminals 120G of the second row R2 through the plurality of second extensions, and electrically couple the second ground terminals 120G together through the body 131.

With the aforementioned configuration, the conductive member 130 can electrically couple the first ground terminals 110G and the second ground terminals 120G together. In some embodiments, the conductive member 130 may be formed from a metallic material such as a copper or copper alloy. In this case, each extension of the conductive member 130 may be in direct contact with the intermediate portion of the corresponding ground terminal. In some other embodiments, the conductive member 130 may be formed from a lossy material. In this case, each extension of the conductive member 130 may be in direct contact or capacitive coupling with the intermediate portion of the corresponding ground terminal.

In some embodiments, as shown in FIGS. 8B to 8C, 8E to 8G, and 9C to 9D, each first extension may be in the form of a second resilient beam 136. A plurality of second resilient beams 136 are disposed in a fourth row (not labeled) in the longitudinal direction Y-Y. The second resilient beams 136 of the fourth row are aligned with and spaced apart from each other in the longitudinal direction Y-Y. Each second resilient beam 136 is configured to be electrically coupled to the first intermediate portion 113 of a corresponding first ground terminal 110G of the first row R1. For example, each second resilient beam 136 extends from the body 131 toward the first intermediate portion 113 of the corresponding first ground terminal 110G (e.g., extends toward the first side), and resiliently abuts against the first intermediate portion 113. In this way, the second resilient beam 136 may be in direct contact with the first intermediate portion 113 of the corresponding first ground terminal 110G.

In some embodiments, as shown in FIGS. 8E to 8G and 9A to 9B, for each first conductive terminal 110 of the first row R1, the first intermediate portion 113 may include a first segment 1131 extending in the vertical direction Z-Z, and a second segment 1132 extending obliquely from the first segment 1131 away from the body 131 of the conductive member 130 toward the slot 47 to the first mating end 111. In other words, the first segment 1131 may be straight in the vertical direction Z-Z. As shown in FIG. 8E, the first segment 1131 of the first intermediate portion 113 of the first conductive terminal 110 of the first row R1 may be coplanar with the plane PL2 parallel to the first main plane PL1. The plane PL2 is perpendicular to the lateral direction X-X.

Each second resilient beam 136 resiliently abuts against the first segment 1131 of the first intermediate portion 113 of the corresponding first ground terminal 110G. In some embodiments, as shown in FIGS. 8B to 8C, 8E to 8G, and 9C to 9D, each second resilient beam 136 may include a first segment 1361 extending obliquely from the body 131 away from the first face 41 and toward the first intermediate portion 113 of the corresponding first ground terminal 110G to the second segment 1362, and a second segment 1362 convexly curved toward the first intermediate portion 113 of the corresponding first ground terminal 110G and forming the mating contact portion (not labeled) to abut against the first intermediate portion 113.

Similar to the first resilient beam 133, each second resilient beam 136 may be a part integrally stamped from the body 131. As shown in FIGS. 9C and 9D, the second resilient beam 136 may have a fixed end 136a and a free end 136b opposite to the fixed end 136a. The mating contact portion of the second resilient beam 136 may be formed adjacent to the free end 136b. The second resilient beam 136 is connected to the body 131 at the fixed end 136a. The fixed end 136a is Indented into the body 131 in the vertical direction Z-Z relative to the second edge 131b of the body 131. As such, as shown in FIGS. 9C and 9D, a plurality of cutouts 137 are formed in the portion of the body 131 adjacent to the second edge 131b. The portion of the body 131 is divided into a plurality of subportions 138 by the plurality of cut-outs 137. Every adjacent two subportions 138 of the plurality of subportions 138 are separated by a corresponding cutout 137 in the longitudinal direction Y-Y. As will be described in detail below, each of the plurality of subportions 138 may be aligned, in the lateral direction X-X, with a corresponding subset of first signal terminals 110S (e.g., a single first signal terminal 110S or a pair of first signal terminals 110S forming a differential signal pair). With such a configuration, it is possible to provide a better shielding effect, thereby improving signal integrity.

It should be appreciated that in some other embodiments, the plurality of first extensions of the conductive member 130 may be in the form of protrusions (e.g., ribs), tabs, or any other suitable form.

In some embodiments, as shown in FIGS. 8A to 8H, the first terminal group 100 may include an insulative subassembly housing 140. The subassembly housing 140 is disposed around the second intermediate portions 123 of the plurality of second conductive terminals 120 to hold the plurality of second conductive terminals 120. The subassembly housing 140 may include a plurality of openings 141 each aligned with the second intermediate portion 123 of a corresponding second ground terminal 120G of the second row R2 in the lateral direction X-X and exposing a portion of the second intermediate portion 123. Each opening 141 may be elongated in the vertical direction Z-Z.

The body 131 of the conductive member 130 may be disposed on the subassembly housing 140, and each second extension (e.g., the rib 139, which will be described in detail below) is aligned with and received in a corresponding opening 141 of the plurality of openings 141 in the lateral direction X-X, so as to be in direct contact or capacitive coupling with the portion of the second intermediate portion 123 of the corresponding second ground terminal 120G.

In some embodiments, as shown in FIGS. 8B, 8H, 9C, and 9D, each second extension is in the form of a rib 139. The rib 139 protrudes from the second face 131f of the body 131 in the lateral direction X-X. The rib 139 may include a bottom segment 139a, a first side segment 139b, and a second side segment 139c. The bottom segment 139a of each rib 139 may be in direct contact or capacitive coupling with the portion of the second intermediate portion 123 of the corresponding second ground terminal 120G. The first side segment 139 b and the second side segment 139 c may be opposing to each other in the longitudinal direction Y-Y and connect the bottom segment 139a to the body 131, respectively.

As shown in FIGS. 8E to 8G and 9E to 9F, for each second conductive terminal 120 of the second row R2, the second intermediate portion 123 may extend in the vertical direction Z-Z. In other words, the second intermediate portion 123 may be straight in the vertical direction Z-Z. As shown in FIG. 8E, the second intermediate portions 123 of the second conductive terminals 120 of the second row R2 may be coplanar in a plane PL3 parallel to the first main plane PL1. The plane PL3 is perpendicular to the lateral direction X-X and parallel to the aforementioned plane PL2. In some embodiments, as shown in FIG. 8E, the spacing between the plane PL3 and the first main plane PL1 may be less than the spacing between the plane PL2 and the first main plane PL1.

In some embodiments, as shown in FIGS. 8F and 8H, for each rib 139, the bottom segment 139a is in direct contact with the portion of the second intermediate portion 123 of the corresponding second ground terminal 120G, and the direct contact is a face contact. The face contact can reduce the impedance at the connection parts between the rib 139 and the second ground terminal 120G, and mitigate or even eliminate the charge accumulation problem, thereby improving the signal transmission performance of the first terminal group 100.

In some embodiments, as shown in FIG. 8H, the cross section of each rib 139 perpendicular to the vertical direction Z-Z may be U-shaped. In other words, each rib 139 may have a U-shaped configuration. In some embodiments, each rib 139 may be a part integrally stamped from the body 131. In this case, each rib 139 is a U-shaped segment integrally stamped from the body 131.

In some embodiments, the position of the fixed end 133b of each first resilient beam 133 may be aligned, in the vertical direction Z-Z, with the position where a corresponding rib 139 is formed on the body 131.

In some embodiments, for each rib 139, the bottom segment 139a may be attached to the portion of the second intermediate portion 123 of the corresponding second ground terminal 120G by any suitable process, such as laser welding. In this way, the conductive member 130 may be secured to the subassembly housing 140. This enables the elimination of other securing mechanisms or features for securing the conductive member 130 to the subassembly housing 140, thereby simplifying the manufacturing and assembly of the first subassembly 100 and facilitating reducing the size of the first terminal group 100 in the lateral direction X-X.

In some embodiments, the length of the portion of the second intermediate portion 123 of the second ground terminal 120G corresponding to each rib 139 in the vertical direction Z-Z occupies more than 50% (e.g., 50%, 60%, 70%, 80%, or 90%) of the total length of the second intermediate portion 123 in the vertical direction Z-Z. In the case where the attachment of the bottom segment 139a to the second intermediate portion 123 is via welding, a line weld may be formed along the second intermediate portion 123 in the vertical direction Z-Z. The line weld may occupy more than 50%, such as 60%, 70%, 80%, or 90%, of the total length of the second intermediate portion 123 in the vertical direction Z-Z. The aspect ratio of length to width of the line weld may be greater than 2:1, e.g., in some examples, the aspect ratio may be greater than 5:1 or greater than 10:1.

With such a configuration, the ribs 139 can be reliably connected to the second ground terminal 120G, thereby reliably holding the conductive members 130 and the conductive terminals of the second row R2 in position with respect to each other. Furthermore, since each rib 139 of the conductive member 130 is received in the corresponding opening 141, the speed and accuracy of connecting the conductive member 130 to the second ground terminals 120G of the second row R2 can be improved, thereby improving the manufacturing efficiency and yield of the first terminal group 100.

In some embodiments, as shown in FIGS. 8B and 8C, the subassembly housing 140 may include a first face 140a and a second face 140b. The first face 140a and the second face 140b may each be planar. The first face 140a and the second face 140b may extend parallel to the first main plane PL1 of the body 131 of the conductive member 130, respectively. The plurality of openings 141 may be recessed into the subassembly housing 140 from the first face 140a in the lateral direction X-X. The second face 131f of the body 131 of the conductive member 130 may also be planar. When the body 131 of the conductive member 130 is disposed on the subassembly housing 140, the second face 131f of the body 131 is placed on the first face 140a of the subassembly housing 140 and each rib 139 is received in the corresponding opening 141.

It should be appreciated that in some other embodiments, the body 131 of the conductive member 130 may be secured on the subassembly housing 140 in any suitable manner, such as a snap fit, so that the rib 139 is in direct contact or capacitive coupling with the second ground terminal 120G.

It should also be appreciated that in some other embodiments, the plurality of second extensions of the conductive member 130 may be in the form of resilient beams, tabs, or any other suitable form.

In some embodiments, the subassembly housing 140 is a member overmolded on the second intermediate portions 123 of the plurality of second conductive terminals 120. In some other embodiments, the subassembly housing 140 may be pre-fabricated and the plurality of second conductive terminals 120 may be inserted into the subassembly housing 140.

In some embodiments, as shown in FIG. 8H, in the case where the second signal terminals 120S and the second ground terminals 120G of the second row R2 are alternately disposed in the longitudinal direction Y-Y, for each second signal terminal 120S, the center of the second intermediate portion 123 may be spaced apart from the body 131 of the conductive member 130 by a first distance D1 in the lateral direction X-X, and may be spaced apart from the edge of the adjacent second ground terminal 120G by a second distance D2 in the longitudinal direction Y-Y. In some embodiments, the first distance D1 may be less than the second distance D2. With such a configuration, the body 131 of the conductive member 130 may act as the closest ground reference for the second signal terminal 120S. In some embodiments, the first distance D1 may be equal to the second distance D2 so that the second signal terminal 120S is shielded in a manner similar to the manner in which a wire with coaxial cables is shielded.

In some embodiments, as shown in FIG. 8H, for each second signal terminal 120S, the second intermediate portion 123 may be separated from the body 131 of the conductive member 130 by the subassembly housing 140 in the lateral direction X-X.

The first terminal group 100 may be configured to be entirely disposed in the insulative housing 40. In some embodiments, the subassembly housing 140 is configured to be disposed in the insulative housing 40. For example, the insulative housing 40 may be molded around the subassembly housing 140. As another example, the subassembly housing 140 may be configured to be inserted into the insulative housing 40. As shown in FIGS. 3E, 3F, 4B, and 4D, the insulative housing 40 may include a first channel 40a and a plurality of second channels 40b. The first channel 40a may be recessed into the insulative housing 40 from the second face 42 in the vertical direction Z-Z and extend in the longitudinal direction Y-Y. The plurality of second channels 40b may be recessed into the insulative housing 40 in the vertical direction Z-Z from the second face 42 and extend between the first channel 40a and the slot 47 in the lateral direction X-X. The subassembly of the subassembly housing 140, the plurality of second conductive terminals 120, and the conductive member 130 may be inserted into the insulative housing 40 through the first channel 40a and the second channels 40b. For example, the second mating ends 121 and the second intermediate portions 123 of the plurality of second conductive terminals 120 may be received in the first channel 40a and the second channels 40b, and the subassembly housing 140 and the conductive member 130 may be received in the first channel 40a. The subassembly housing 140 may include a snap protrusion 142 (FIGS. 4D and 8B) protruding from the second face 140b for snapping into a recess 40c (FIG. 4D) disposed at an inner wall of the first channel 40a to hold the subassembly housing 140 in the first channel 40a.

In some embodiments, the plurality of first conductive terminals 110 may be configured to be held in position directly by the insulative housing 40. For example, the insulative housing 40 may be molded around the plurality of first conductive terminals 110 to hold the plurality of first conductive terminals 110. As another example, the plurality of first conductive terminals 110 may be configured to be inserted into the insulative housing 40. As shown in FIGS. 3E, 3F, 4B, and 4D, each of the plurality of first conductive terminals 110 may be configured to be inserted into a corresponding second channel 40b of the insulative housing 40. The first intermediate portion 113 of each first conductive terminal 110 may be held by a pair of receiving slots 40d (FIG. 3F) recessed into an inner wall of the second channel 40b, thereby holding the first conductive terminal 110 in position.

In this case, when the electrical connector 10 is manufactured, a subassembly of the subassembly housing 140, the plurality of second conductive terminals 120, and the conductive member 130 may be first formed. For example, the plurality of second conductive terminals 120 may be held with the subassembly housing 140, and then the conductive member 130 is disposed on the subassembly housing 140 and coupled to the second ground terminals 120G of the plurality of second conductive terminals 120. Next, the subassembly may be inserted into the insulative housing 40, and then the plurality of first conductive terminals 110 may be inserted into the insulative housing 40.

It should be appreciated that the detailed configurations of the first subassembly 100 are not limited thereto. For example, in some other embodiments, an additional subassembly housing may be included. The additional subassembly housing may hold the plurality of first conductive terminals 110 and may be inserted into the insulative housing 40. As another example, the additional subassembly housing may hold the subassembly and the plurality of first conductive terminals 110 together and may be inserted into the insulative housing 40. As another example, the plurality of first conductive terminals 110, the plurality of second conductive terminals 120, and the conductive member 130 may be directly held by the insulative housing 40, and thus there is no subassembly housing 140. As yet another example, the subassembly housing 140 may hold the plurality of first conductive terminals 110, the plurality of second conductive terminals 120, and the conductive member 130 together. As yet another example, the subassembly of the subassembly housing 140, the plurality of second conductive terminals 120, and the conductive member 130 may be attached to or inserted into the insulative housing 40 in the lateral direction X-X, instead of being inserted into the insulative housing 40 in the vertical direction Z-Z as described above.

In some embodiments, as shown in FIGS. 8D and 8G, the dimension of the body 131 of the conductive member 130 between the first edge 131a and the second edge 131b in the vertical direction Z-Z may be greater than or equal to the length of the second intermediate portion 123 of each second signal terminal 120S in the vertical direction Z-Z. With such a configuration, the conductive member 130 can provide shielding along the signal transmission path of the second signal terminals 120S, thereby improving signal transmission performance.

In some embodiments, as shown in FIGS. 8D and 8G, the dimension of the body 131 of the conductive member 130 between the third edge 131c and the fourth edge 131d in the longitudinal direction Y-Y may be greater than or equal to the length of each of the first row R1 and the second row R2 in the longitudinal direction Y-Y. With such a configuration, the conductive member 130 can provide shielding along the signal transmission paths of the signal terminals of the first row R1 and the second row R2, thereby improving signal transmission performance.

As shown in FIGS. 8A and 8E to 8F, the first tail ends 112 of the plurality of first conductive terminals 110 are located on a first side of the body 131 of the conductive member 130 adjacent to the slot 47 in the lateral direction X-X, and the second tail ends 122 of the plurality of second conductive terminals 120 are located on a second side of the body 131 opposite to the first side in the lateral direction X-X. In some embodiments, as shown in FIGS. 8E to 8F, the body 131 of the conductive member 130 does not extend to a position between the first tail ends 112 of the plurality of first conductive terminals 110 and the second tail ends 122 of the plurality of second conductive terminals 120 in the vertical direction Z-Z. For example, the second edge 131b of the body 131 of the conductive member 130 may be flush with the joint of the first tail end 112 and the first intermediate portion 113 of the first conductive terminal 110 and the joint of the second tail end 122 and the second intermediate portion 123 of the second conductive terminal 120.

In some embodiments, the conductive member 130 may have no portion to be directly electrically connected to the first circuit board 20. In some other embodiments, the conductive member 130 may have a structure or feature that is directly electrically connected with a conductive pad or through hole of the first circuit board 20.

As previously described, the first tail ends 112 of the plurality of first conductive terminals 110 and the second tail ends 122 of the plurality of second conductive terminals 120 may be configured to establish electrical connections with corresponding conductive pads on the surface 20a of the first circuit board 20.

In some embodiments, as shown in FIGS. 3D to 3E, 5, 8A, 9A to 9B, and 9E to 9F, the electrical connector 10 may include a plurality of solder balls 400, and each of the first tail ends 112 of the plurality of first conductive terminals 110 and the second tail ends 122 of the plurality of second conductive terminals 120 is configured to be attached with a solder ball 400 (FIG. 5) and to be connected to a corresponding conductive pad (not shown) on the first circuit board 20 with the solder ball when the electrical connector 10 is mounted onto the first circuit board 20.

For example, the first tail ends 112 of the plurality of first conductive terminals 110 and the second tail ends 122 of the plurality of second conductive terminals 120 of the first terminal group 100 may be configured to be connected to corresponding conductive pads on the first circuit board 20 by BGA attachment. BGA attachment is a surface mount technology (SMT). The solder balls 400 may be tin balls, for example. Solder balls 400 may be fused onto the tail ends 112 and 122 of the conductive terminals 110 and 120. This may be accomplished by heating the solder to sufficiently liquefy and adhere to the tail ends 112 and 122. When mounting the electrical connector 10 to the first circuit board 20, the electrical connector 10 may be placed on the surface 20a of the first circuit board 20 so that the tail ends 112 and 122 of the conductive terminals 110 and 120 and the solder balls 400 attached thereto are aligned with corresponding conductive pads on the surface 20a of the first circuit board 20. Next, the solder balls 400 may be heated (e.g., by placing the electrical connector 10 and the first circuit board 20 in a reflow oven) and melted to adhere to the conductive pads, while the solder balls 400 remain adhered to the tail ends 112 and 122. After the solder balls 400 has cooled, the tail ends 112 and 122 are connected and secured to the conductive pads via solder balls 400. In this way, the tail ends 112 and 122 are mechanically and electrically connected to the conductive pads by the solder balls 400, thereby establishing reliable electrical connections between the electrical connector 10 and the first circuit board 20. FIG. 3D shows that the tail ends 112 and 122 of the conductive terminals 110 and 120 are attached with the solder balls 400.

In some embodiments, the solder balls 400 may be provided by a manufacturer of the electrical connector 10 and attached to the tail ends 112 and 122 of the conductive terminals 110 and 120 during manufacture of the electrical connector 10. In some other embodiments, the solder balls 400 may be provided by other manufacturers, such as the manufacturer who conducts process on the electrical connector 10 or the manufacturer of the electronic system 1, and may be attached to the tail ends 112 and 122 of the conductive terminals 110 and 120 prior to mounting the electrical connector 10 onto the first circuit board 20.

In some embodiments, as shown in FIGS. 3B, 3D, 4A to 5, and 10A to 10B, the electrical connector 10 may include a cover member 500 (two shown in the figures). The cover member 500 may be disposed on the second face 42 (e.g., the mounting face) of the insulative housing 40. The cover member 500 may include a plurality of apertures 501 each extending through the cover member 500 in the vertical direction Z-Z. Each aperture 501 may be aligned with a corresponding one of the first tail ends 112 of the plurality of first conductive terminals 110 and the second tail ends 122 of the plurality of second conductive terminals 120 to allow the corresponding tail end to pass therethrough. When assembling the electrical connector 10, the cover member 500 may be mounted to the insulative housing 40 before the solder balls 400 are attached to the tail ends 112 and 122 of the conductive terminals 110 and 120. The tail ends 112 and 122 of the conductive terminals 110 and 120 extend through the apertures 501 of the cover member 500 in the vertical direction Z-Z. The solder balls 400 may then be fused onto the tail ends 112 and 122 of the conductive terminals 110 and 120. The cover member 500 may provide a seal at the second face 42 of the insulative housing 40 to prevent solder or foreign material, such as debris, from entering the first channel 40a and the plurality of second channels 40b of the insulative housing 40. The cover member 500 may be mounted to the insulative housing 40 by any suitable means, such as by a snap-fit.

As mentioned above, the first mating ends 111 of the plurality of first conductive terminals 110 (the first signal terminals 110S and the first ground terminals 110G) of the first terminal group 100, the second mating ends 121 of the plurality of second conductive terminals 120 (the second signal terminals 120S and the second ground terminals 120G), and the plurality of first resilient beams 133 of the conductive member 130 are configured to establish electrical connections with corresponding contact pads on the first surface 31a of the first subportion 33 of the edge portion 31 when the second circuit board 30 is inserted into the electrical connector 10.

FIGS. 2A and 2C show an exemplary version of the contact pads of the first surface 31a of the first subportion 33 of the edge portion 31 of the second circuit board 30. As shown in FIG. 2C, the second circuit board 30 may include a ground contact pad 330, a plurality of first signal contact pads 310, and a plurality of second signal contact pads 320 disposed on the first surface 31a.

The plurality of first signal contact pads 310 may be disposed in a first pad row PR1 in the longitudinal direction Y-Y. The first signal contact pads 310 of the first pad row PR1 may be aligned with and spaced apart from each other in the longitudinal direction Y-Y. As will be described in detail below, the first signal contact pads 310 of the first pad row PR1 may include a plurality subsets of signal contact pads, with a single first signal contact pad 310 as a subset and/or with a pair of first signal contact pads 310 as a subset. Each first signal contact pad 310 is configured to contact with the first mating contact portion 111a of the first mating end 111 of a corresponding first signal terminal 110S of the first row R1 of the first terminal group 100.

The plurality of second signal contact pads 320 may be disposed in a second pad row PR2 in the longitudinal direction Y-Y. The second signal contact pads 320 of the second pad row PR2 may be aligned with and spaced apart from each other in the longitudinal direction Y-Y. As will be described in detail below, the second signal contact pads 320 of the second pad row PR2 may include a plurality subsets of signal contact pads, with a single second signal contact pad 320 as a subset and/or with a pair of second signal contact pads 320 as a subset. Each second signal contact pad 320 is configured to contact with the second mating contact portion 121a of the second mating end 121 of a corresponding second signal terminal 120S of the second row R2 of the first terminal group 100.

The ground contact pad 330 may be configured to contact with the first mating contact portion(s) 111a of the first mating end(s) 111 of a selected number (e.g., all) of the first ground terminal(s) 110G of the first row R1 of the first terminal group 100, the second mating contact portion 121a(s) of the second mating end(s) 121 of a selected number (e.g., all) of the second ground terminals 120G of the second row R2, and a third mating contact portion(s) 133 a of a selected number (e.g., all) of the first resilient beams 133 of the conductive member 130, so as to establish electrical interconnections among the first mating contact portion(s) 111a, the second mating contact portion(s) 121a, and the third mating contact portion(s) 133a. The ground contact pad 330 can interconnect the first ground terminals 110G, the second ground terminals 120G, and the first resilient beams 133.

For example, the ground contact pad 330 may include a body 331, a plurality of first extensions 333, and a plurality of second extensions 334. The body 331 is disposed between the first pad row PR1 and the second pad row PR2 in the vertical direction Z-Z and extends continuously in the longitudinal direction Y-Y.

Each first extension 333 extends from the body 331 in the vertical direction Z-Z to a position between corresponding adjacent two subsets of first signal contact pads 310 of the first pad row PR1 to separate the corresponding adjacent two subsets of first signal contact pads 310 from each other in the longitudinal direction Y-Y. Each subset of first signal contact pad 310 may include a single first signal contact pad 310 or a pair of first signal contact pads 310. In other words, the first signal contact pads 310 of the first pad row PR1 may include a plurality subsets of signal contact pads, with a single first signal contact pad 310 as a subset and/or with a pair of first signal contact pads 310 as a subset, and the first extensions 333 extends to positions between adjacent subsets of the plurality subsets of signal contact pads in the vertical direction Z-Z to separate the plurality subsets of signal contact pads from each other. One first extension 333 may be disposed between adjacent subsets. Each first extension 333 may act as a first ground contact pad for contacting the first mating contact portion 111a of the first mating end 111 of a corresponding first ground terminal 110G of the first row R1 of the first terminal group 100.

Each second extension 334 extends from the body 331 in the vertical direction Z-Z to a position between corresponding adjacent two subsets of second signal contact pads 320 of the second pad row PR2 to separate the corresponding adjacent two subsets of the second signal contact pads 320 from each other in the longitudinal direction Y-Y. Each subset of second signal contact pad 320 may include a single second signal contact pad 320 or a pair of second signal contact pads 320. In other words, the second signal contact pads 320 of the second pad row PR2 may include a plurality subsets of signal contact pads, with a single second signal contact pad 320 as a subset and/or with a pair of second signal contact pads 320 as a subset, and the second extensions 334 extend to positions between adjacent subsets of the plurality subsets of signal contact pads in the vertical direction Z-Z to separate the plurality subsets of signal contact pads from each other. There may be one second extension 334 between adjacent subsets. Each second extension 334 may act as a second ground contact pad for contacting the second mating contact portion 121 a of the second mating end 121 of a corresponding second ground terminal 120G of the second row R2 of the first terminal group 100.

Such a configuration of the second circuit board 30 can maintain or improve signal integrity while providing a higher signal contact pad density, thereby enabling the second circuit board 30 to operate at higher speeds and having a greater number of signal contact pads to provide more independent signal paths. The body 331 of the ground contact pad 330 establishes a continuous ground structure between the first extensions 333 and the second extensions 334 to eliminate the potential difference between these extensions as much as possible, and can reduce the affect of crosstalk. Further, such a configuration can reduce the insertion loss (IL) and return loss (RL) of the signals.

FIGS. 7A and 7B illustrate the relative positional relationship between the first terminal group 100 and the second circuit board 30 when the second circuit board 30 is inserted in the electrical connector 10, wherein the insulative housing 40 is omitted. As shown in FIG. 7B, when the second circuit board 30 is inserted in the electrical connector 10, each first signal contact pad 310 is in contact with the first mating contact portion 111a of a corresponding first signal terminal 110S of the first row R1 of the first terminal group 100, each second signal contact pad 320 is in contact with the second mating contact portion 121a of a corresponding second signal terminal 120S of the second row R2 of the first terminal group 100, each first extension 333 of the ground contact pad 330 is in contact with the first mating contact portion 111a of a corresponding first ground terminal 110G of the first row R1 of the first terminal group 100, each second extension 334 of the ground contact pad 330 is in contact with the second mating contact portion 121a of a corresponding second ground terminal 120G of the second row R2 of the first terminal group 100, and the body 331 of the ground contact pad 330 is in contact with the third mating contact portions 133a of the plurality of first resilient beams 133. In this way, ground and signal connections can be established between the second circuit board 30 and the electrical connector 10.

The body 331 may include a first side edge and a second side edge opposite to each other in the vertical direction Z-Z. Each first extension 333 may protrude from the first side edge of the body 331 in the vertical direction Z-Z, and each second extension 334 may protrude from the second side edge of the body 331 in the vertical direction Z-Z. The first signal contact pads 310, the second signal contact pads 320, and the ground contact pad 330 may be formed by any suitable circuit board manufacturing process in the art.

In some embodiments, as shown in FIG. 2C, the body 331 of the ground contact pad 330 may extend straightly in the longitudinal direction Y-Y and be strip-shaped. The plurality of first signal contact pads 310, the plurality of second signal contact pads 320, and the ground contact pad 330 may be disposed in a two-dimensional array on the first surface 31a.

In some embodiments, as shown in FIG. 2C, one or more of the first signal contact pads 310, the second signal contact pads 320, the first extensions 333, and the second extensions 334 may be in a finger shape.

The arrangement (e.g., position and pitch) of the plurality of first signal contact pads 310 and the plurality of first extensions 333 may correspond to the arrangement of the first mating contact portions 111a of the plurality of first conductive terminals 110 (including the first signal terminals 110S and the first ground terminals 110G) of the first terminal group 100.

At least some or all of the plurality of subsets of first signal contact pads 310 may each be disposed in a U-shaped region bounded by two adjacent first extensions 333 and the body 331 of the ground contact pad 330. In some embodiments, as shown in FIG. 2C, the plurality of first signal contact pads 310 and the plurality of first extensions 333 may be alternately disposed in the longitudinal direction Y-Y. For example, in the first pad row PR1, each subset of first signal contact pad 310 includes a single first signal contact pad 310. Every adjacent two first signal contact pads 310 are separated by the first extension 333 in the longitudinal direction Y-Y. The first signal contact pad 310 may be disposed in a U-shaped region bounded by two adjacent first extensions 333 and the body 331 of the ground contact pad 330.

In some other embodiments, in the case where each subset of first signal contact pad 310 includes a pair of first signal contact pads 310, each pair of first signal contact pads 310 may be disposed in the U-shaped region bounded by two adjacent first extensions 333 and the body 331 of the ground contact pad 330. Such configurations can reduce the affect of crosstalk, thereby improving signal integrity.

The arrangement (position and pitch) of the plurality of second signal contact pads 320 and the plurality of second extensions 334 may correspond to the arrangement of the second mating contact portions 121a of the plurality of second conductive terminals 120 (including the second signal terminals 120S and the second ground terminals 120G) of the first terminal group 100.

At least some or all of the plurality of subsets of second signal contact pads 320 may each be disposed in a U-shaped region bounded by two adjacent second extensions 334 and the body 331 of the ground contact pad 330. In some embodiments, as shown in FIG. 2C, the plurality of second signal contact pads 320 and the plurality of second extensions 334 may be alternately disposed in the longitudinal direction Y-Y. For example, in the second pad row PR2, each subset of second signal contact pad 320 includes a single second signal contact pad 320. Every adjacent two second signal contact pads 320 are separated by the second extension 334 in the longitudinal direction Y-Y. The second signal contact pad 320 may be disposed in a U-shaped region bounded by two adjacent second extensions 334 and the body 331 of the ground contact pad 330.

In some other embodiments, in the case where each subset of second signal contact pad 320 includes a pair of second signal contact pads 320, each pair of second signal contact pads 320 may be disposed in a U-shaped region bounded by two adjacent second extensions 334 and the body 331 of the ground contact pad 330. Such configurations can reduce the affect of crosstalk, thereby improving signal integrity.

Each subset of first signal contact pad 310 of the first pad row PR1 may be aligned with a corresponding one of the plurality of second extensions 334 in the vertical direction Z-Z, and each subset of second signal contact pad 320 of the second pad row PR2 may be aligned with a corresponding one of the plurality of first extensions 333 in the vertical direction Z-Z. For example, the first signal contact pads 310 of the first pad row PR1 are offset from the second signal contact pads 320 of the second pad row PR2 in the vertical direction Z-Z, and the plurality of first extensions 333 are offset from the plurality of second extensions 334 in the vertical direction Z-Z.

Such an arrangement enables the first pad row PR1 and the second pad row PR2 to be disposed at a smaller spacing in the vertical direction Z-Z while still maintaining sufficient spacing between the first signal contact pads 310 and the second signal contact pads 320. Such an arrangement enables to provide the signal contact pads on the same side of the edge portion 31 of the second circuit board 30 in a double-density without significantly increasing the size of the edge portion 31 of the second circuit board 30 in the vertical direction Z-Z.

In some embodiments, as shown in FIG. 2C, in the case where the plurality of first signal contact pads 310 and the plurality of first extensions 333 are alternately disposed in the longitudinal direction Y-Y and the plurality of second signal contact pads 320 and the plurality of second extensions 334 are alternately disposed in the longitudinal direction Y-Y, each first signal contact pad 310 may be aligned with a corresponding one of the plurality of second extensions 334 in the vertical direction Z-Z, and each second signal contact pad 320 may be aligned with a corresponding one of the plurality of first extensions 333 in the vertical direction Z-Z. For example, the first signal contact pads 310 of the first pad row PR1 are offset from the second signal contact pads 320 of the second pad row PR2 in the vertical direction Z-Z, and the plurality of first extensions 333 are offset from the plurality of second extensions 334 in the vertical direction Z-Z.

In some other embodiments, although not shown in the figures, it is contemplated that in the case where each subset of first signal contact pad 310 includes a pair of first signal contact pads 310 and each subset of second signal contact pad 320 includes a pair of second signal contact pads 320, each pair of first signal contact pads 310 may be aligned with a corresponding one of the plurality of second extensions 334 in the vertical direction Z-Z, and each pair of second signal contact pads 320 may be aligned with a corresponding one of the plurality of first extensions 333 in the vertical direction Z-Z. In this case, the widths of the first extensions 333 and the second extensions 334 may have a sufficient width (e.g., equal to the width of the pair of signal contact pads) to ensure that the pairs of signal contact pads of the two pad rows are offset from each other in the vertical direction Z-Z.

In some embodiments, the first signal contact pad 310 and the first extension 333 adjacent to each other in the first pad row PR1 may be spaced apart by a first distance (not labeled in the figures) in the longitudinal direction Y-Y, and the second signal contact pad 320 and the second extension 334 adjacent to each other in the second pad row PR2 may be spaced apart by a second distance (not labeled in the figures) in the longitudinal direction Y-Y, the first distance is equal to the second distance.

The detailed configurations, the manufacturing method, and the arrangement manner of the first terminal group 100 of the set of terminal groups disposed in the first section 47a of the slot 47 and the configurations and the electrical connection manner of the first circuit board 20 and the second circuit board 30 associated with the first terminal group 100 have been described above.

The inventors have recognized and appreciated that providing the second terminal group 200 to have a similar configuration as the first terminal group 100 can provide double density conductive terminals on both sides of the slot 47 of the electrical connector 10, thereby further improving signal transmission performance of the electrical connector 10.

As shown in FIGS. 6A and 6B, the second terminal group 200 may include a plurality of third conductive terminals 210, a plurality of fourth conductive terminals 220 (including fourth signal terminals 220S and fourth ground terminals 220G), a conductive member 230, and a subassembly housing 240. The plurality of third conductive terminals 210 are disposed in a third row in the longitudinal direction Y-Y and include third signal terminals 210S and third ground terminals 210G. The plurality of fourth conductive terminals 220 are disposed in a fourth row in the longitudinal direction Y-Y and include fourth signal terminals 220S and fourth ground terminals 220G. The conductive member 230 is disposed between the third row and the fourth row and is electrically coupled to the third ground terminal(s) 210G and the fourth ground terminal(s) 220G.

The configurations of the plurality of third conductive terminals 210, the plurality of fourth conductive terminals 220, the conductive member 230, and the subassembly housing 240 of the second terminal group 200 may be similar to those of the plurality of first conductive terminals 110, the plurality of second conductive terminals 120, the conductive member 130, and the subassembly housing 140 of the first terminal group 100, respectively, except that the components of the second terminal group 200 may be configured to be disposed on the other side of the first section 47a in the lateral direction X-X. Thus, for the sake of brevity, the details of the second terminal group 200 will not be repeated.

In some embodiments, as described above and as shown in FIGS. 6B and 6C, in the first row R1, the first signal terminals 110S and the first ground terminals 110G are alternately disposed in the longitudinal direction Y-Y, and in the second row R2, the second signal terminals 120S and the second ground terminals 120G are alternately disposed in the longitudinal direction Y-Y. Similar to the first terminal group 100, in the third row of the second terminal group 200, the third signal terminals 210S and the third ground terminals 210G are alternately disposed in the longitudinal direction Y-Y, and in the fourth row, the fourth signal terminals 220S and the fourth ground terminals 220G are alternately disposed in the longitudinal direction Y-Y. The first row R1 of the first terminal group 100 is closer to the slot 47 than the second row R2 in the lateral direction X-X, and the third row of the second terminal group 200 is closer to the slot 47 than the fourth row in the lateral direction X-X. Each first signal terminal 110S of the first row R1 is aligned, in the lateral direction X-X, with a corresponding second ground terminal 120G of the second row R2, a corresponding third ground terminal 210G of the third row, and a corresponding fourth signal terminal 220S of the fourth row. Each second signal terminal 120S of the second row R2 is aligned, in the lateral direction X-X, with a corresponding first ground terminal 110G of the first row R1, a corresponding third signal terminal 210S of the third row, and a corresponding fourth ground terminal 220G of the fourth row. For example, the first signal terminals 110S of the first row R1 are offset from the second signal terminals 120S of the second row R2 and the third signal terminals 210S of the third row in the lateral direction X-X, and the third signal terminals 210S of the third row are offset from the first signal terminals 110S of the first row R1 and the fourth signal terminals 220S of the fourth row in the lateral direction X-X. Such a configuration enables the first terminal group 100 and the second terminal group 200 to be disposed at a smaller spacing in the lateral direction X-X. This facilitates miniaturization of the electrical connector 10 and can reduce the space of the electrical connector 10 occupied on the first circuit board 20.

As an example, the number of conductive terminals of each terminal row of the first terminal group 100 and the second terminal group 200 may be 2N, where N is a positive integer. For example, the number of conductive terminals of each terminal row may be an even number. For example, as shown in FIGS. 6B and 6C, the first row R1 and the second row R2 of the first terminal group 100 may each have thirty-six conductive terminals, with eighteen being signal terminals and the other eighteen being ground terminals. In the first row R1, the first signal terminals 110S and the first ground terminals 110G are alternately disposed in the longitudinal direction Y-Y and disposed in a manner of “G-S-G-S- . . . G-S”, and in the second row R2, the second signal terminals 120S and the second ground terminals 120G are alternately disposed in the longitudinal direction Y-Y and disposed in a manner of “S-G-S-G- . . . S-G”. Similar to the first terminal group 100, the third row and the fourth row of the second terminal group 200 may each have thirty-six conductive terminals, with eighteen being signal terminals and the other eighteen being ground terminals. In the third row, the third signal terminals 210S and the third ground terminals 210G are alternately disposed in the longitudinal direction Y-Y and disposed in a manner of “S-G-S-G- . . . S-G”, and in the fourth row, the fourth signal terminals 220S and the fourth ground terminals 220G are alternately disposed in the longitudinal direction Y-Y and are disposed in a manner of “G-S-G-S- . . . G-S”. The signal terminals in every adjacent two rows of the first row, the second row, the third row, and the fourth row are offset from each other in the lateral direction X-X.

In this embodiment, as shown in FIGS. 6B and 6C, the configurations of the second terminal group 200 may be symmetrical to the configurations of the first terminal group 100. For example, the configurations of the first terminal group 100 and the configurations of the second terminal group 200 may be 180°-rotationally symmetric about an axis extending in the vertical direction Z-Z and through the midpoint of the slot section between the first terminal group 100 and the second terminal group 200.

It should be appreciated that in some other embodiments, the configurations of the first terminal group 100 and the configurations of the second terminal group 200 may be mirror symmetric about the slot section between the first terminal group 100 and the second terminal group 200. Further, it should be appreciated that in some other embodiments, the number of conductive terminals of each terminal row of the first terminal group 100 and the second terminal group 200 may be an odd number. It is contemplated that in this case the signal terminals of every adjacent two rows of the first row, the second row, the third row, and the fourth row may still be offset from each other in the lateral direction X-X.

Although it has been described above that in each of the first row, the second row, the third row, and the fourth row, the signal terminals include a plurality of signal terminal subsets with a single signal terminal as a subset, and the ground terminals are disposed between adjacent subsets of the plurality of signal terminal subsets, it should be appreciated that in some other embodiments, the signal terminals may include a plurality of signal terminal subsets, with a pair of signal terminals as a subset, and the ground terminals are disposed between adjacent subsets of the plurality of signal terminal subsets. In this case, the ground terminals may have a sufficient width (e.g., equal to the width of a pair of signal terminals) to ensure that the signal terminals of every two adjacent rows are offset from each other in the lateral direction X-X. Each pair of signal terminals may be configured as a differential signal pair. In this case, the conductive member may still be configured to interconnect the ground terminals together to achieve the above advantages.

As shown in FIGS. 7A and 7B, when the second circuit board 30 is inserted in the electrical connector 10, similar to the first terminal group 100, the second terminal group 200 may be in contact with corresponding contact pads on the second surface 31b of the first subportion 33 of the edge portion 31, thereby establishing electrical connections between the electrical connector 10 and the second circuit board 30. The first subportion 33 of the edge portion 31 is sandwiched between the first terminal group 100 and the second terminal group 200. As shown in FIG. 2B, the contact pad pattern on the second surface 31b of the first subportion 33 of the edge portion 31 may be similar to the contact pad pattern on the first surface 31a to achieve mating with the plurality of third conductive terminals 210, the plurality of fourth conductive terminals 220, and the conductive member 230 of the second terminal group 200. Thus, for brevity, details of the similar parts will not be repeated.

The detailed configuration of the electrical connector 10 has been described above in connection with the set of terminal groups disposed in the first section 47a of the slot 47. It is contemplated that the configurations of the other three sets of terminal groups (each set includes one first terminal group 100 and one second terminal group 200) may be the same as or similar to the configurations of the set of terminal groups described above, and that the other three sets of terminal groups may mate with corresponding contact pads on the edge portion 31 of the second circuit board 30 in a similar manner and mounted to the conductive pads on the surface 20a of the first circuit board 20 in a similar manner, thereby establishing electrical connections between the first circuit board 20 and the second circuit board 30. For brevity, details of the similar parts will not be repeated.

Furthermore, it should be appreciated that the number of the first terminal groups 100 and the second terminal groups 200 of the electrical connector 10 is not limited thereto. The electrical connector 10 may have more or fewer of the first terminal groups 100 and the second terminal groups 200, or may have only the first terminal group 100 or the second terminal group 200.

Although it has been described above that the first resilient beams of the conductive member is in direct contact with the contact ground pad of the second circuit board to electrically couple the body of the conductive member to the contact ground pad, it should be appreciated that the present application is not limited thereto. In some other embodiments, the conductive member may include extensions, such as protrusions (e.g., ribs), tabs, or in any other suitable form, for electrically coupling (via directly contacting or capacitively coupling) the body of the conductive member to the contact ground pad of the second circuit board.

Although it has been described above that the body of the conductive member has a plate shape, it should be appreciated that the shape of the conductive member is not limited thereto. For example, the conductive member may have a flat bar shaped body. As another example, the conductive member may be in the form of a corrugated plate.

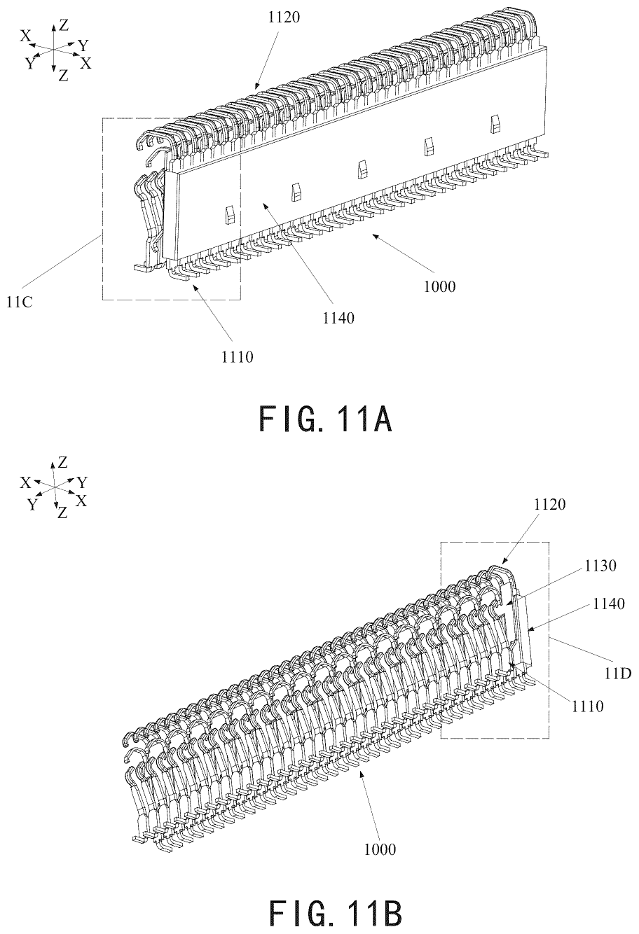

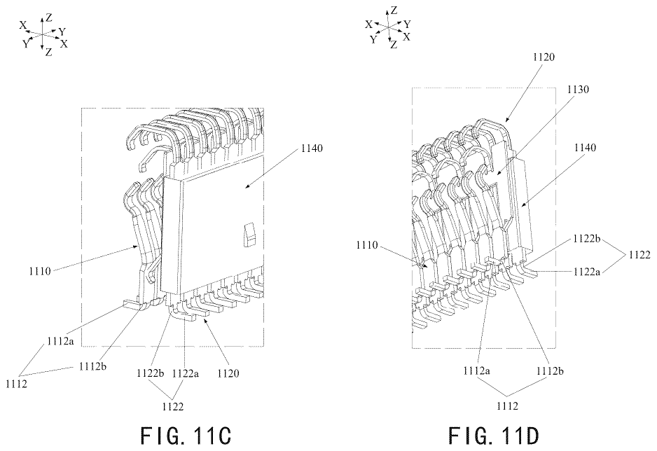

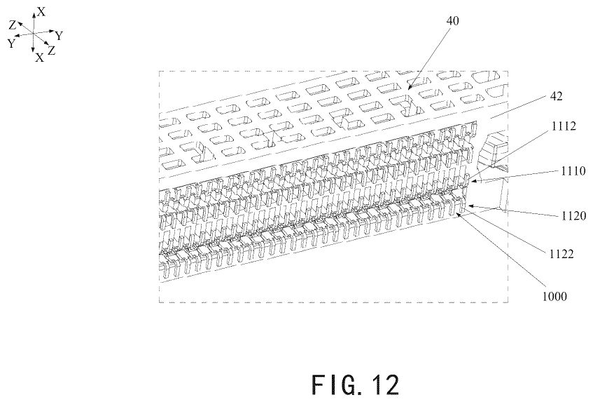

FIGS. 11A to 12 illustrate another version of the first terminal group. The first terminal group is labeled “1000” in FIGS. 11A to 12. FIGS. 11A to 11D illustrate the detailed configurations of the first terminal group 1000, and FIG. 12 illustrates the case where the first terminal group 1000 is mounted into the aforementioned insulative housing 40. Similar to the first terminal group 100 shown in FIGS. 8A to 9F, the first terminal group 1000 may include a plurality of first conductive terminals 1110, a plurality of second conductive terminals 1120, a conductive member 1130, and a subassembly housing 140. The configurations and function of the plurality of first conductive terminals 1110, the plurality of second conductive terminals 1120, the conductive member 1130, and the subassembly housing 1140 of the first terminal group 1000 are substantially the same as those of the plurality of first conductive terminals 110, the plurality of second conductive terminals 120, the conductive member 130, and the subassembly housing 140 of the first terminal group 100, except that the shape of the tail ends of the conductive terminals are different. Thus, for the sake of brevity, the details of the same parts will not be repeated.

The first tail ends 1112 of the first conductive terminals 1110 and the second tail ends 1122 of the second conductive terminals 1120 of the first terminal group 1000 are configured to be adapted to be soldered directly to the corresponding conductive pads of the first circuit board 20 by SMT technique, rather than by BGA attachment. Thus, the electrical connector with the first terminal group 1000 may not have the solder balls 400 and the cover member 500 described above. The conductive pads of the first circuit board 20 may also be changed accordingly to be adapted for soldering the tail ends 1112 and 1122 of the conductive terminals 1110 and 1120.

As shown in FIGS. 11C and 11D, the first tail end 1112 of each first conductive terminal 1110 may include a first straight segment 1112a and a first curved segment 1112b. The first curved segment 1112b extends between an intermediate portion (not labeled in the figures) and the first straight segment 1112a of the first conductive terminal 1110 and is curved away from the body of the conductive member 1130, so that the first straight segment 1112a and the intermediate portion are oriented perpendicular to each other. The second tail end 1122 of each second conductive terminal 1120 may include a second straight segment 1122a and a second curved segment 1122b. The second curved segment 1122b extends between an intermediate portion (not labeled in the figures) and the second straight segment 1122a of the second conductive terminal 1120 and is curved away from the body of the conductive member 130, so that the second straight segment 1122a and the intermediate portion are oriented perpendicular to each other. The first straight segments 1112a of the plurality of first conductive terminals 110 and the second straight segments 1122a of the plurality of second conductive terminals 120 are oriented in opposite directions from each other and are respectively configured for soldering to corresponding conductive pads of the first circuit board 20.

For example, when the electrical connector 10 is mounted to the first circuit board 20, the solder paste may first be applied on the conductive pads of the first circuit board 20, and then the electrical connector 10 is placed on the first circuit board 20, so that the tail ends 1112 and 1122 of the conductive terminals 1110 and 1120 are positioned on corresponding conductive pads of the first circuit board 20. Next, the solder paste may be heated (e.g., by placing the electrical connector 10 and the first circuit board 20 in a reflow oven) and melted to adhere to the tail ends 1112 and 1122 of the conductive terminals 1110 and 1120, while the solder paste remains adhered to the conductive pads. After the solder paste has cooled, the tail ends 1112 and 1122 are connected and secured to the conductive pads by the solder paste. As another example, the tail ends 1112 and 1122 of the conductive terminals 1110 and 1120 may be directly connected to corresponding conductive pads of the first circuit board 20 by laser welding or ultrasonic welding. Reliable electrical connections can be established between the electrical connector 10 and the first circuit board 20 in any one of these manners.

It is contemplated that the tail ends of the conductive terminals of the second terminal group 200 may be shaped similarly to the tail ends 1112 and 1122 of the conductive terminals 1110 and 1120 of the first terminal group 1000. For brevity, details of the similar parts will not be repeated.

Although it has been described above that the conductive terminals are connected to conductive pads of the circuit board via SMT technology, it should be appreciated that in some other embodiments, the tail ends of the conductive terminals may be connected to corresponding conductive structures of the circuit board via any other suitable attachment means, such as through-hole technology (THT).

Although it has been described above that the electrical connector 10 is configured as a vertical card edge connector, it should be appreciated that in some other embodiments, the electrical connector 10 may be configured as any other suitable type of connector, such as a right angle electrical connector, a straddle mount electrical connector, and a cable connector. In these cases, the configurations of the tail ends of the conductive terminals may be correspondingly modified. For example, the electrical connector 10 may be configured to be attached with cables. The tail ends of the conductive terminals may be configured to be welded to the cables. As another example, the tail ends of the conductive terminals may be configured to be inserted into conductive through holes in the circuit board.

Although it has been described above that the electrical connector 10 is configured to receive a card, it should be appreciated that in some other embodiments, the electrical connector 10 may be configured to mate with any other suitable type of electrical component, such as another electrical connector (e.g., a plug connector).

Some of the conductive elements in a row may be used as high-speed signal conductors. Optionally, some of the conductive elements may be used as low-speed signal conductors or power conductors. Some of the low-speed signal conductors and/or power conductors may also be designated as ground to give reference to the signals being carried on the signal conductors or to provide a return path for those signals. It should be appreciated that the ground conductor does not need to be connected to earth ground, but may carry a reference potential, which may include earth ground, DC voltage or other suitable reference potential.

Although described above is the situation in which high-speed and low-speed signal conductors may be configured the same, with signal conductors in the same row having the same shape, the high-speed and low-speed signal conductors nonetheless may be differentiated based on the ground structures and insulative portions around them. Alternatively, some or all of the high speed signal conductors may be configured differently from the low speed signal conductors, even in the same row.

Materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz or 1 GHz to 5 GHz. Alternatively, lossy material may be identified from measurements made at a single frequency, such as 10 GHz or 15 GHz.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest such that the material conducts more poorly than a conductor of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and a conductor, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with frequencies in the range of approximately 10 GHz or higher, a reduction in the amount of electromagnetic energy in a conductor may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to a conductor, coupling may be measured at a test frequency, such as 15 GHz or over a test range, such as 10 GHz to 25 GHz.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHz and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions also may be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, lossy portions may be formed by plating plastic or other insulative material with a lossy coating, such as a diffuse metal coating.

Having thus described several embodiments, it is to be appreciated various alterations, modifications, and improvements may readily occur to those skilled in the art. Such alterations, modifications, and improvements are intended to be part of this disclosure, and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated, those of ordinary skill in the art will readily envision a variety of other means and/or structures for performing the function and/or obtaining the results and/or one or more of the advantages described, and each of such variations and/or modifications is deemed to be within the scope of the inventive embodiments described. More generally, those skilled in the art will readily appreciate that all parameters, dimensions, materials, and configurations described are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure may be directed to each individual feature, system, system upgrade, and/or method described. In addition, any combination of two or more such features, systems, and/or methods, if such features, systems, system upgrade, and/or methods are not mutually inconsistent, is included within the inventive scope of the present disclosure.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A terminal group for an electrical connector comprising a housing having a slot elongated in a longitudinal direction, the terminal group configured to be disposed on one side of the slot, the terminal group comprising:
a plurality of first conductive terminals disposed in a first row extending in the longitudinal direction, the plurality of first conductive terminals comprising first signal terminals and first ground terminals;
a plurality of second conductive terminals disposed in a second row extending in the longitudinal direction and spaced from the first row in a lateral direction perpendicular to the longitudinal direction, the plurality of second conductive terminals comprising second signal terminals and second ground terminals; and
a conductive member disposed between the first row and the second row and electrically connecting the first ground terminals of the plurality of first conductive terminals in the first row and the second ground terminals of the plurality of second conductive terminals in the second row.

2. The terminal group of claim 1, wherein:
each first conductive terminal comprises a first mating end having a first mating contact portion curving into the slot from said side of the slot; and
each second conductive terminal comprises a second mating end having a second mating contact portion curving into the slot from said side of the slot.

3. The terminal group of claim 2, wherein:
the conductive member comprises a plurality of first resilient beams disposed in a third row extending in the longitudinal direction; and
each first resilient beam comprises a third mating contact portion curving into the slot from said side of the slot.

4. The terminal group of claim 3, wherein:
the first mating contact portions of the plurality of first conductive terminals are aligned in a first line;
the second mating contact portions of the plurality of second conductive terminals are aligned in a second line parallel to the first line and spaced from the first line in a vertical direction perpendicular to both the longitudinal direction and the lateral direction; and
the third mating contact portions of the plurality of first resilient beams are aligned in a third line, the third line parallel to the first line and between the first line and the second line in the vertical direction.

5. The terminal group of claim 4, wherein:
the first line, the second line, and the third line are coplanar in a plane perpendicular to the lateral direction.

6. The terminal group of claim 3, wherein:
the conductive member comprises a plate-shaped body.

7. The terminal group of claim 6, wherein:
each first conductive terminal comprises a first tail end and a first intermediate portion between the first mating end and the first tail end, both the first intermediate portion and the first mating end disposed on a first side of the body of the conductive member; and
each second conductive terminal further comprises a second tail end and a second intermediate portion between the second mating end and the second tail end, the second intermediate portion disposed on a second side of the body of the conductive member opposite to the first side in the lateral direction, and the second mating end disposed on the first side of the conductive member.

8. The terminal group of claim 7, wherein:
the conductive member comprises a plurality of second resilient beams extending from the body and toward the first intermediate portions of respective first ground terminals of the plurality of first conductive terminals.

9. The terminal group of claim 8, wherein:
the conductive member comprises a plurality of extensions extending from the body and toward the second intermediate portions of respective second ground terminals.

10. An electrical connector comprising:
a housing comprising a slot elongated in a longitudinal direction; and
a terminal group disposed on one side of the slot, the terminal group comprising:
a plurality of first conductive terminals held by the housing in a first row extending in the longitudinal direction,
a subassembly housing disposed in the housing and comprising a plurality of openings,
a plurality of second conductive terminals held by the subassembly housing in a second row extending in the longitudinal direction, intermediate portions of second ground conductive terminals at least partially exposed by respective openings of the plurality of openings of the subassembly housing, and
a conductive member disposed on the subassembly housing and comprising a plurality of extensions extending into respective openings of the plurality of openings of the subassembly housing so as to electrically connect the second ground conductive terminals with first ground conductive terminals.

11. The electrical connector of claim 10, wherein:
the plurality of extensions of the conductive member are welded to the intermediate portions of the second ground conductive terminals.

12. The electrical connector of claim 10, wherein:
the first ground conductive terminals and first signal conductive terminals are disposed in alternative in the first row;
the second ground conductive terminals and second signal conductive terminals are disposed in alternative in the second row;
the first ground conductive terminals are aligned with respective second signal conductive terminals in a lateral direction perpendicular to the longitudinal direction; and
the second ground conductive terminals are aligned with respective first signal conductive terminals in the lateral direction.

13. The electrical connector of claim 12, wherein:
the conductive member comprises a plurality of first resilient beams aligned with respective second ground conductive terminals in the lateral direction.

14. The electrical connector of claim 13, wherein:
each first conductive terminal comprises a first mating end having a first mating contact portion curving into the slot;
each second conductive terminal comprises a second mating end having a second mating contact portion curving into the slot; and
each first resilient beam comprises a third mating contact portion curving into the slot.

15. The electrical connector of claim 14, wherein:
the first mating contact portions are aligned in a first line;
the second mating contact portions are aligned in a second line parallel to the first line and spaced from the first line in a vertical direction perpendicular to both the longitudinal direction and the lateral direction; and
the third mating contact portions are aligned in a third line, the third line parallel to the first line and between the first line and the second line in the vertical direction.

16. The electrical connector of claim 13, wherein:
the conductive member comprises a plurality of second resilient beams aligned with respective first ground conductive terminals in the lateral direction.

17. A card, comprising:
an edge portion configured to be inserted into a slot of an electrical connector in a vertical direction and comprising a first surface and a second surface opposite to each other in a lateral direction perpendicular to the vertical direction;
a plurality of first signal contact pads disposed on the first surface, the plurality of first signal contact pads disposed in a first row in a longitudinal direction perpendicular to the vertical direction and the lateral direction and comprising a plurality of subsets;
a plurality of second signal contact pads disposed on the first surface, the plurality of second signal contact pads disposed in a second row in the longitudinal direction and comprising a plurality of subsets; and
a ground contact pad disposed on the first surface and comprising:
a body disposed between the first row and the second row in the vertical direction and extending in the longitudinal direction;
a plurality of first extensions each extending from the body in the vertical direction to a position between corresponding two adjacent subsets of first signal contact pads of the first row; and
a plurality of second extensions each extending from the body in the vertical direction to a position between corresponding two adjacent subsets of second signal contact pads of the second row.

18. The card of claim 17, wherein:
each subset of first signal contact pad of the first row is aligned with a corresponding one of the plurality of second extensions in the vertical direction; and
each subset of second signal contact pad of the second row is aligned with a corresponding one of the plurality of first extensions in the vertical direction.

19. The card of claim 18, wherein:
each subset of first signal contact pad of the first row is disposed in a U-shaped region bounded by two adjacent first extensions and the body of the ground contact pad; and
each subset of second signal contact pad of the second row is disposed in a U-shaped region bounded by two adjacent second extensions and the body of the ground contact pad.

20. The card of claim 18, wherein:
each subset of first signal contact pad of the first row comprises a single first signal contact pad, and the plurality of first signal contact pads and the plurality of first extensions are alternately disposed in the longitudinal direction; and
each subset of second signal contact pad of the second row comprises a single second signal contact pad, and the plurality of second signal contact pads and the plurality of second extensions are alternately disposed in the longitudinal direction.
